(19) United States
(12) Patent Application Publication
(10) Pub. No.: US 2025/0358427 A1
(43) Pub. Date: Nov. 20, 2025

(54) TECHNIQUES FOR TRANSFORM KERNEL SET SELECTION/DERIVATION

(71) Applicant: Tencent America LLC, Palo Alto, CA (US)

(72) Inventors: Biao WANG, San Jose, CA (US); Yonguk YOON, Palo Alto, CA (US); Shan LIU, San Jose, CA (US); Yifan WANG, Palo Alto, CA (US); Lien-Fei CHEN, Palo Alto, CA (US); Roman CHERNYAK, Santa Clara, CA (US); Ziyue XIANG, Palo Alto, CA (US); Motong XU, Palo Alto, CA (US); Tianqi LIU, Palo Alto, CA (US)

(73) Assignee: Tencent America LLC, Palo Alto, CA (US)

(21) Appl. No.: 19/212,522

(22) Filed: May 19, 2025

Related U.S. Application Data
(60) Provisional application No. 63/649,920, filed on May 20, 2024.
(60) Provisional application No. 63/653,058, filed on May 29, 2024.
(60) Provisional application No. 63/712,387, filed on Oct. 25, 2024.
(60) Provisional application No. 63/712,383, filed on Oct. 25, 2024.
(60) Provisional application No. 63/717,269, filed on Nov. 6, 2024.
(60) Provisional application No. 63/717,834, filed on Nov. 7, 2024.
(60) Provisional application No. 63/718,520, filed on Nov. 8, 2024.

(51) Int. Cl. H04N 19/159; H04N 19/122; H04N 19/176; H04N 19/196; H04N 19/61

(52) U.S. Cl. CPC H04N 19/159; H04N 19/122; H04N 19/176; H04N 19/196; H04N 19/61

(57) ABSTRACT

An aspect of the disclosure provides a method of video decoding. For example, a coded video bitstream is received. The coded video bitstream includes coded information of a plurality of pictures. Based on coded information of a current block in a current picture, it is determined that the current block is coded using an intra prediction that generates prediction samples of the current block based on reference samples in the current picture. At least a first transform kernel set is determined based on a histogram of occurrence (HoC) of intra prediction modes in neighboring samples of the current block. Based on the coded information of the current block, a residual block of the current block is calculated according to at least the first transform kernel set. The current block is reconstructed based on the residual block and the intra prediction of the current block.

### INCORPORATION BY REFERENCE

The present application claims the benefit of priority to U.S. Provisional Application No. 63/649,920, filed on May 20, 2024, U.S. Provisional Application No. 63/653,058, filed on May 29, 2024, U.S. Provisional Application No. 63/712,383, filed on Oct. 25, 2024, U.S. Provisional Application No. 63/712,387, filed on Oct. 25, 2024, U.S. Provisional Application No. 63/717,269, filed on Nov. 6, 2024, U.S. Provisional Application No. 63/717,834, filed on Nov. 7, 2024, and U.S. Provisional Application No. 63/718,520, filed on Nov. 8, 2024. The entire disclosures of the prior applications are hereby incorporated by reference in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

An aspect of the disclosure provides a method of video decoding. For example, a coded video bitstream is received. The coded video bitstream includes coded information of a plurality of pictures. Based on coded information of a current block in a current picture, it is determined that the current block is coded using an intra prediction that generates prediction samples of the current block based on reference samples in the current picture. At least a first transform kernel set is determined based on a histogram of occurrence (HoC) of intra prediction modes in neighboring samples of the current block. Based on the coded information of the current block, a residual block of the current block is calculated according to at least the first transform kernel set. The current block is reconstructed based on the residual block and the intra prediction of the current block.

Another aspect of the disclosure provides a method of video decoding. For example, a coded video bitstream is received. The coded video bitstream includes coded information of a plurality of pictures. Based on coded information of a current block in a current picture, it is determined that the current block is coded in an adaptive transform kernel derivation mode with intra and inter partitions, the current block is partitioned into at least a first partition and a second partition, the first partition is predicted based on a vector that points to a reference block and the second partition is predicted by an intra prediction. An intra prediction mode is determined from a plurality of candidate intra prediction modes for the current block based on the coded information of the current block. A transform kernel set is determined based on the intra prediction mode. A residual block of the current block is determined according to the transform kernel set and the coded information of the current block. The current block is reconstructed based on the residual block, the reference block of the first partition and the intra prediction of the second partition.

Aspects of the disclosure also provide an apparatus for video encoding. The apparatus for video encoding including processing circuitry configured to implement any of the described methods for video encoding.

Aspects of the disclosure also provide a method for video decoding. The method including any of the methods implemented by the apparatus for video decoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a diagram of intra prediction modes in some examples.

FIG. 5 shows a diagram of intra prediction modes in some examples.

FIG. 6 shows an example of using a decoder-side intra mode derivation (DIMD) mode for a reconstruction of a current block.

FIG. 7 shows a diagram of positions of non-adjacent spatial neighboring blocks of a current block in some examples.

FIG. 8 shows a diagram of a histogram of occurrence of intra prediction modes in the spatial neighborhood of a current block in an example.

FIG. 9 shows a flow chart outlining a process according to an aspect of the disclosure.

FIG. 10 shows a flow chart outlining a process according to an aspect of the disclosure.

FIG. 11 shows a table in an example.

FIG. 12 shows a table in an example.

FIG. 13 shows a flow chart outlining a process according to an aspect of the disclosure.

FIG. 14 shows a flow chart outlining a process according to an aspect of the disclosure.

FIG. 15 shows a flow chart outlining a process according to an aspect of the disclosure.

FIG. 16 shows a flow chart outlining a process according to an aspect of the disclosure.

FIG. 17 shows a flow chart outlining a process according to an aspect of the disclosure.

FIG. 18 shows a flow chart outlining a process according to an aspect of the disclosure.

FIG. 19 shows a flow chart outlining a process according to an aspect of the disclosure.

FIG. 20 shows a flow chart outlining a process according to an aspect of the disclosure.

FIG. 21 shows a diagram of 24 angles that are used in the GPM in some examples.

FIG. 22 shows a diagram of possible partition edges for the angle index 3 in an example.

FIG. 23 shows an example of a table that maps LFNST sets to intra prediction modes.

FIG. 24 shows a diagram of a histogram of gradients for predicted samples of the current block in an example.

FIG. 25 shows a flow chart outlining a process according to an aspect of the disclosure.

FIG. 26 shows a flow chart outlining a process according to an aspect of the disclosure.

FIG. 27 shows a diagram of a histogram of gradients in some examples.

FIG. 28 shows a diagram different partition schemes for luma and chroma in some examples.

FIG. 29 shows a flow chart outlining a process according to an aspect of the disclosure.

FIG. 30 shows a flow chart outlining a process according to an aspect of the disclosure.

FIG. 31 shows a diagram of a current block with a template area in some examples.

FIGS. 32A-32B show diagrams of a current block for decoder-side intra mode derivation in some examples.

FIG. 33 shows a diagram of a zig-zag scan order in a current block for building a histogram of gradients in some examples.

FIG. 34 shows a diagram of early termination condition of histogram building based on a threshold value in some examples.

FIG. 35 shows a diagram of a current block with an L-shaped template in some examples.

FIG. 36 shows a diagram of a current block with an L-shaped template in some examples.

FIG. 37 shows a flow chart outlining a process according to an aspect of the disclosure.

FIG. 38 shows a flow chart outlining a process according to an aspect of the disclosure.

FIG. 39 shows a computer system in some examples.

### DETAILED DESCRIPTION

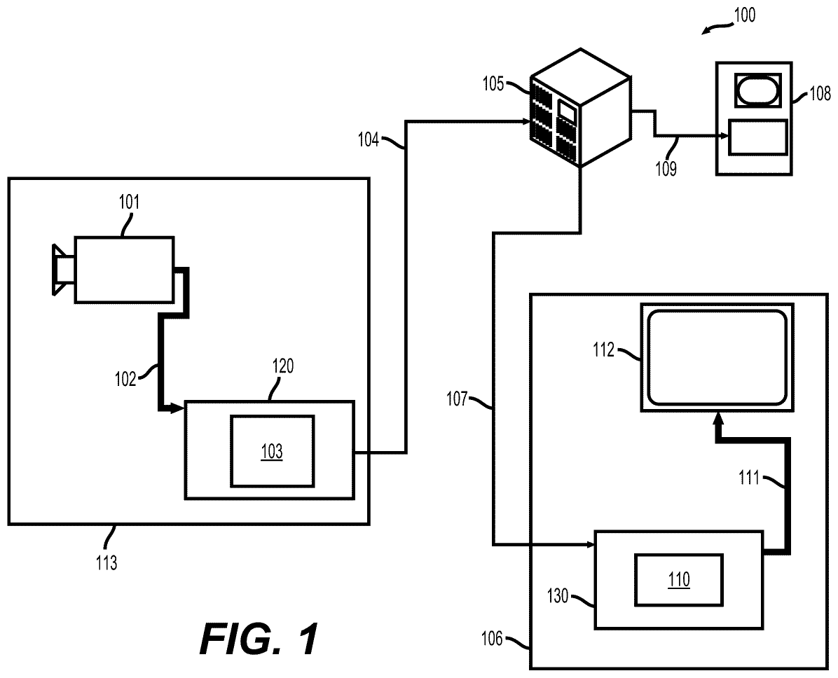

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

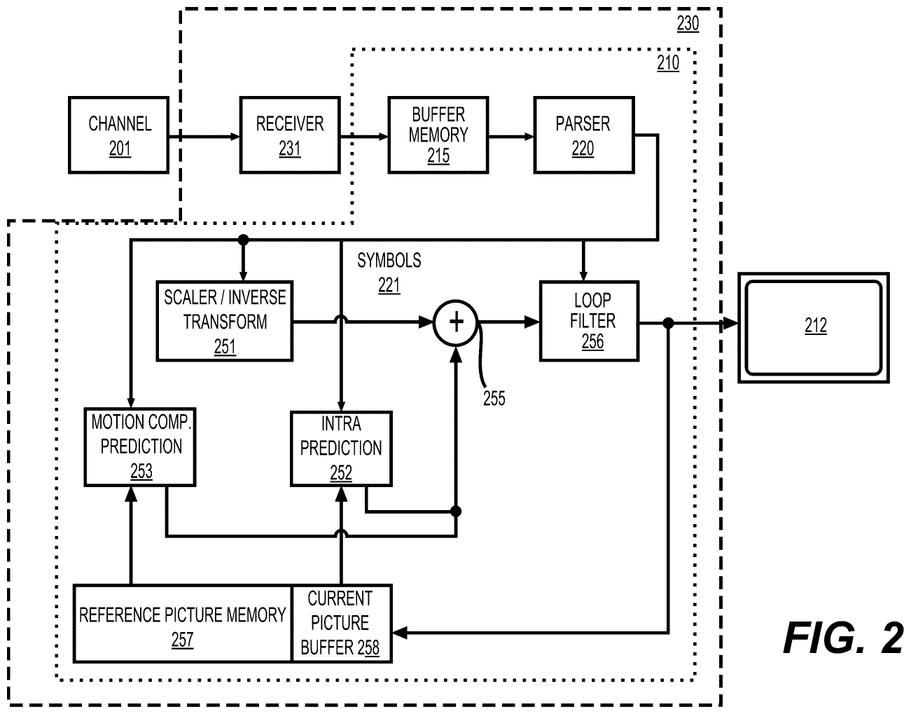

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

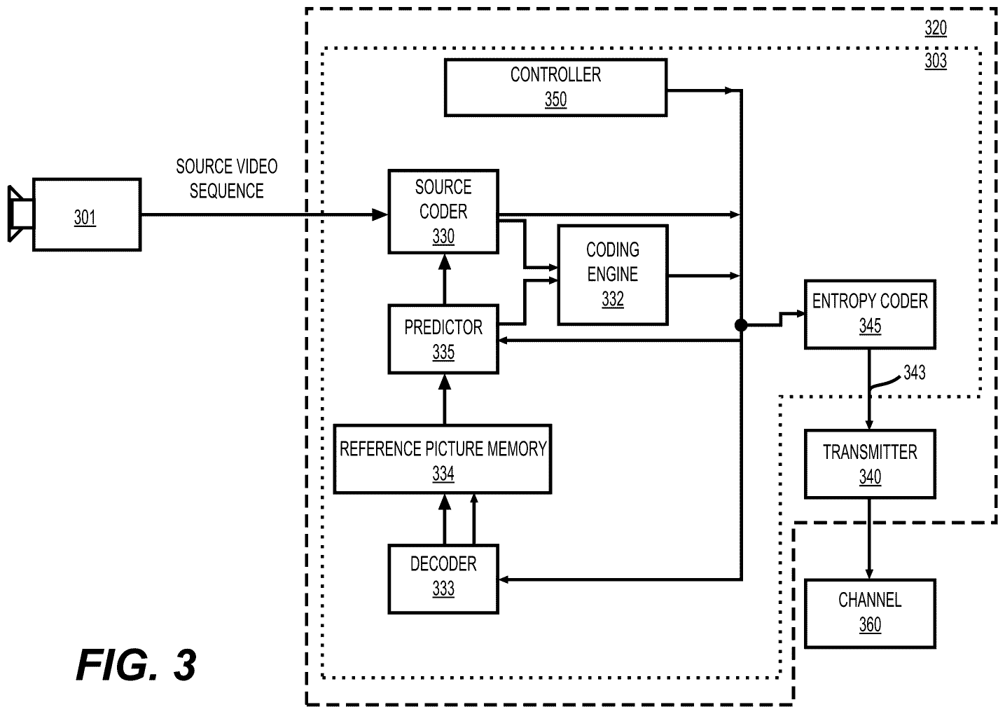

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Some aspects of the disclosure provide techniques of transform kennel set selection/derivation.

Video coding has been widely used in many applications. Video coding standards, such as H264, H265, H266(VVC), AV 1 and AVS, can be adopted in video codec for video coding.

Intra prediction techniques can be used video and/or image coding to use reference data from a current picture under reconstruction for sample prediction. Intra prediction explores spatial redundancy between a current block and its neighboring samples. Intra prediction modes are used in some intra prediction techniques. Intra prediction modes can be classified as directional modes (also referred to as angular modes) and non-directional modes, indicating directional or non-directional correlation between neighboring reference blocks and current block. In some examples, the intra mode information can be explicitly signaled via syntax in the bitstream. Based on the signaled intra mode, a corresponding predictor is generated based on reference samples.

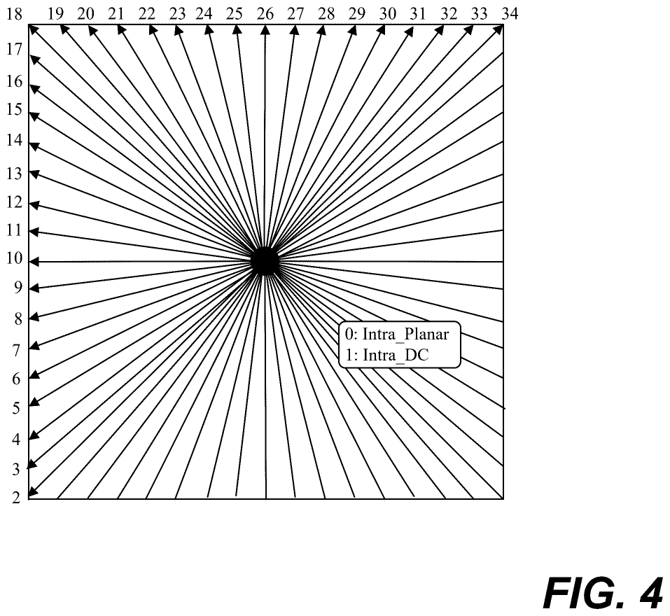

FIG. 4 shows a diagram of intra prediction modes in some examples, such as HEVC. For example, HEVC uses a total of 35 intra prediction modes (e.g., mode 0 to mode 34). Among the 35 intra prediction modes, some modes are directional modes and some modes are non directional modes. In some examples, mode 0 and mode 1 are non directional modes, for example, mode 0 is a planar mode, and mode 1 is DC mode. Further, mode 2 to mode 34 can be directional modes, for example, mode 10 is horizontal mode, mode 26 is vertical mode, and mode 2, mode 18 and mode 34 are diagonal modes, and the like. Values of samples in a coding block are determined according to the neighboring references samples in the same picture and the intra prediction mode of the coding block. In an example, in the DC mode, a mean value is calculated by averaging reference samples in the same picture and can be used for flat surfaces. In another example, in the planar mode, the value of each sample in the coding block is calculated assuming an amplitude surface with a horizontal and vertical smooth gradient derived from the boundaries samples of the neighboring blocks. In some examples, the reference samples include neighboring samples in a row immediately above the coding block and/or include neighboring samples in a column immediately left of the coding block.

In some examples, the intra prediction modes are signaled based on a list of most probable modes (MPMs), and remaining modes. For example, for a coding block, an MPM list is determined. In an example, the MPM list includes 3 modes from the 35 intra prediction modes. Then, when the specific intra prediction mode of the coding block is one of the 3 modes in the MPM list, an index indicative of the one of the 3 modes is used for signaling. When the specific intra prediction mode of the coding block is not one of the 3 modes in the MPM list, an index indicative of one from the remaining modes (32 modes) is used for signaling. In some examples, the MPM list can include other suitable number of modes, such as 6, 10, and the like.

It is noted other suitable number of intra prediction modes can be used.

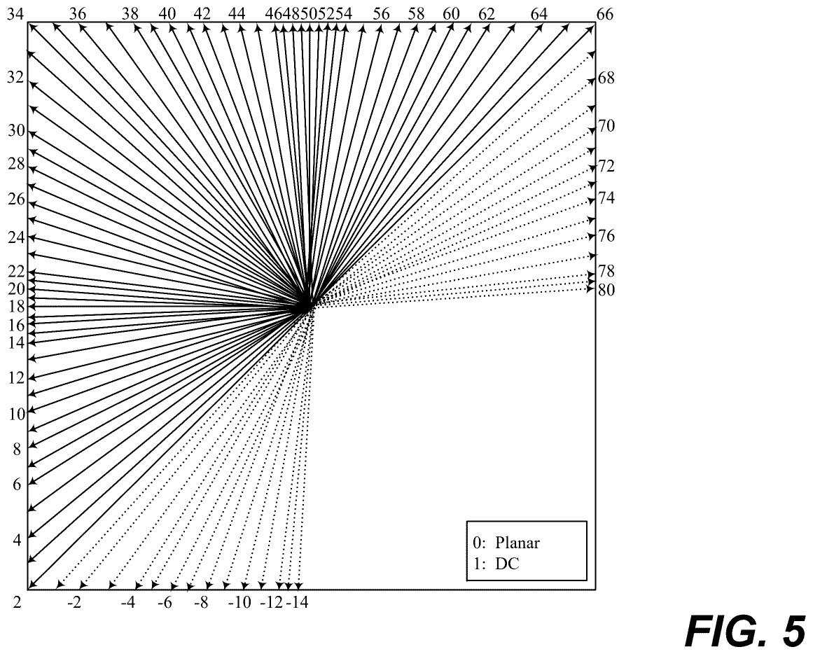

FIG. 5 shows a diagram of intra prediction modes in some examples, such as VVC. In some examples, VVC can use a total of 95 intra prediction modes, such as mode −14 to mode 80. Among the 95 intra prediction modes, mode 0 is a planar mode, mode 1 is DC mode, mode 18 is horizontal mode, mode 50 is vertical mode, and mode 2, mode 34 and mode 66 are diagonal modes. Modes −1 to −14 and modes 67 to 80 are referred to wide-angle intra prediction (WAIP) modes in some examples.

In some examples, to code an intra mode (also referred to as intra prediction mode) of a coding block (e.g., a luma block, chroma blocks of a coding unit), a most probable mode (MPM) list of size 3 is built based on the intra modes of the neighboring blocks of the coding block. The MPM list can be referred to as the MPM list or primary MPM list. If the intra mode of the coding block is not from the MPM list, a flag is signaled to indicate whether intra mode belongs to the selected modes in the MPM list.

In some examples, when an intra prediction mode of a current block is determined, samples in the current block can be generated based on reference samples, such as neighboring samples that already reconstructed.

Intra prediction explores spatial redundancy between a current block and neighboring samples of the current block. For example, to code a block using intra prediction, multiple intra prediction modes may be defined, and a selection of one of the multiple intra prediction modes may be predicted and further signaled. Different intra prediction modes may generate prediction sample values using different predefined models. The different predefined models may include (1) averaging neighboring samples, (2) interpolating the prediction samples using neighboring samples with a given prediction direction, such as in an angular intra prediction mode, and the like to predict a sample in the current block. In some examples, due to the correlation of spatial textures in image and/or video content, intra prediction modes selected for adjacent blocks may be highly correlated. Accordingly, intra prediction mode(s) of the current block may not need to be signaled. Instead, the intra prediction mode(s) of the current block may be derived by analyzing a template of the current block.

In some codec examples (e.g., VVC), multiple transform types, such as type-2 DCT (DCT-2), type-7 DST (DST-7), type-8 DCT (DCT-8), and the like can be used in the primary transform. In some examples, techniques that are referred to as multiple transform selection (MTS) can be used. In an example, an explicit MTS can use a signal to explicitly indicate a selection of a transform kernel. In another example, an implicit MTS can implicitly derive a selection of a transform kernel. In some aspects, the explicit MTS can be applied to both intra and inter coded blocks, while the implicit MTS can be used only for intra coded blocks. In an aspect, in the explicit MTS, the choice of DST-7/DCT-8 is indicated by explicit signaling of the transform type. In another aspect, in implicit MTS, the transform type is selected based on coded information that is known to both the encoder and decoder, and transform type signaling is not needed.

In some examples, in the explicit MTS, the index (e.g., denoted by mts_idx) is signaled at the end of CU level syntax to indicate the transform type for horizontal transform and vertical transform. In an example, the value of mts_idx ranges from 0 to 4. For example, value 0 of mts_idx indicates a use of DCT-2 for horizontal transform and vertical transform; value 1 of mts_idx indicates a use of DST-7 for horizontal transform and vertical transform; value 2 of mts_idx indicates a use of DCT-8 for horizontal transform and DST-7 for vertical transform; value 3 of mts_idx indicates a use of DST-7 for horizontal transform and DCT-8 for vertical transform; and value 4 of mts_idx indicates a use of DCT-8 for horizontal transform and vertical transform.

In some examples, secondary transform can be applied following the primary transform. For example, low-frequency non-separable transform (LFNST) is a non-separable transform that can be applied to the top-left low-frequency region of primary transform coefficients. In some examples (e.g., VVC), the LFNST can be applied for intra coded blocks that use DCT-2 as the primary transform. The transform kernels defined in LFNST can include multiple transform sets, such as 4 transform sets in VVC. In some examples, a selection of a transform set from the four LFNST sets (e.g., denoted by lfnstSetIdx), depends on the intra prediction mode (e.g., denoted by intraPredMode).

In some aspects, the intra mode can be implicitly derived from the decoder sider. For example, the intra mode information can be derived from a pre-defined area of reconstructed samples. For example, a template adjacent to the current block can be used and the intra mode is derived based on gradient. The gradient-based intra mode derivation generates a histogram of gradients using adjacent neighboring samples of the current block. Based on the histogram, the top N gradients are respectively mapped to intra modes, and predictors based on the intra modes can be combined into a final predictor. In some examples, the derived intra prediction modes can be included in the MPM list.

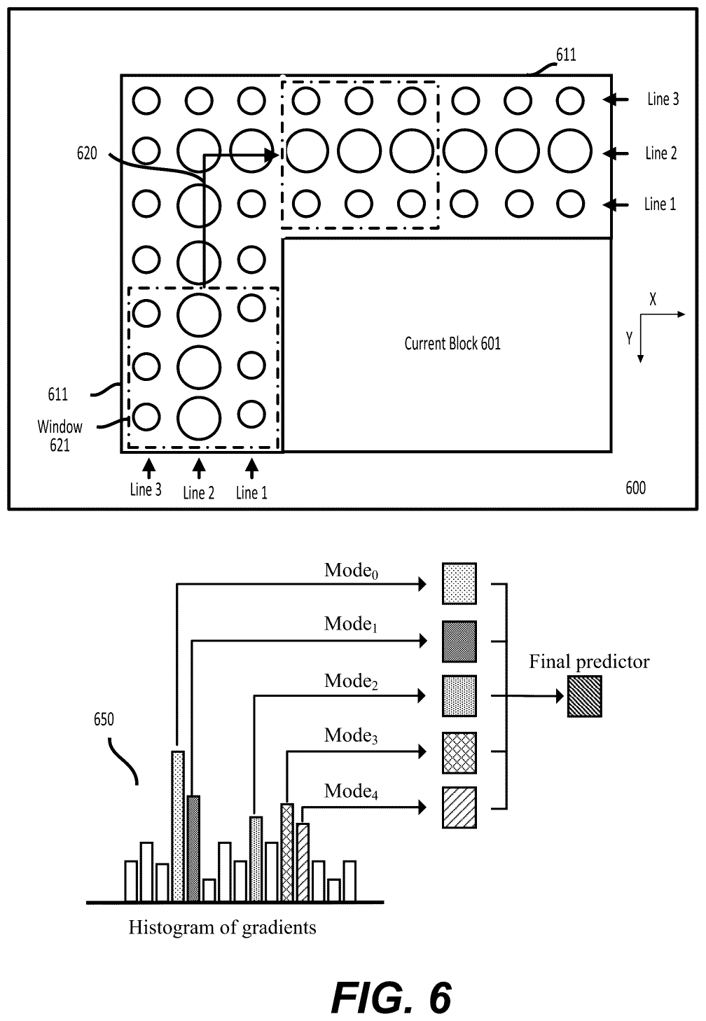

FIG. 6 shows an example of using a decoder-side intra mode derivation (DIMD) mode for a reconstruction of a current block. In the FIG. 6 example, a current block (601) in a current picture can be coded in a DIMD mode, one or more intra prediction modes are derived based on reconstructed samples (also referred to as reconstructed neighboring samples) in a template (611) of the current block (601), and the one or more intra prediction modes can be used to predict the current block (601).

In some examples, to derive the one or more intra prediction modes, gradients of samples in the template (611) are calculated, and a histogram of the gradients is used to derive the one or more intra prediction modes.

In an example, filter(s) (e.g., a Sobel filter) can be used to calculate the gradients in the template (611). For example, a horizonal Sobel 3×3 filter and a vertical Sobel 3×3 filter are applied on a window of 3×3 samples at a position (such as shown by window (621) in FIG. 6) to calculate a horizonal gradient Gx and vertical gradient Gy of the 3×3 samples associated with the position of the template (611). In an example, the window (621) can slide across the template (611) as shown by (620) in FIG. 6 to various positions, to calculate gradients associated with various positions in the template (611).

In some examples, a histogram of the gradients is constructed based on the reconstructed samples in the template (611). From the histogram, one or more dominant gradients can be matched to one or more intra prediction modes.

In the FIG. 6 example, a histogram of gradients (650) is constructed based on gradients associated with positions in the template (611). A gradient at a position is indicated as a radio of the horizonal gradient Gx and the vertical gradient Gy in an example.

Further, in the FIG. 6 example, five most frequent gradients are determined based on the histogram of gradients (650), the five most frequent gradients are respectively matched to five intra prediction modes. In an example, a final predictor is generated based on the five intra prediction modes.

It is noted that in the decoder-side intra mode derivation (DIMD) mode, the histogram can be constructed based on other suitable parameters. In some examples, the intra mode derivation is based on the occurrence of intra modes of the neighboring blocks. The neighboring blocks include adjacent and non-adjacent blocks.

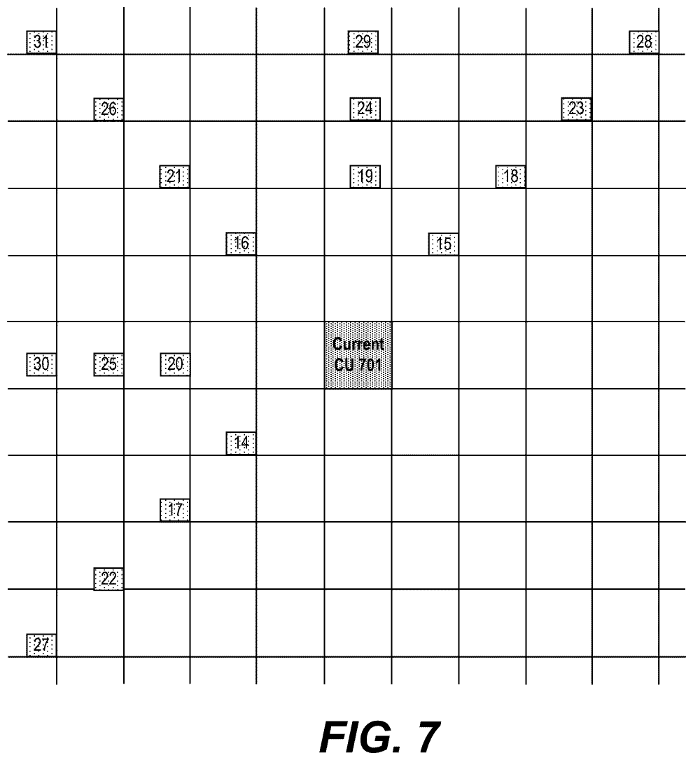

FIG. 7 shows a diagram of positions of non-adjacent spatial neighboring blocks of a current block (701) in some examples.

In some examples, by checking the occurrence of intra modes in the neighboring blocks, such as adjacent neighboring blocks, non-adjacent neighboring blocks (e.g., non-adjacent spatial neighboring blocks 14-31 in FIG. 7) and the like, a histogram of occurrence (HoC) is built. The HoC includes the intra modes and occurrence values of the intra modes, such as the sample-wise occurrences of the intra modes. The sample-wise occurrence values are calculated based on the number of samples that are coded in a certain intra prediction mode in that neighborhood block.

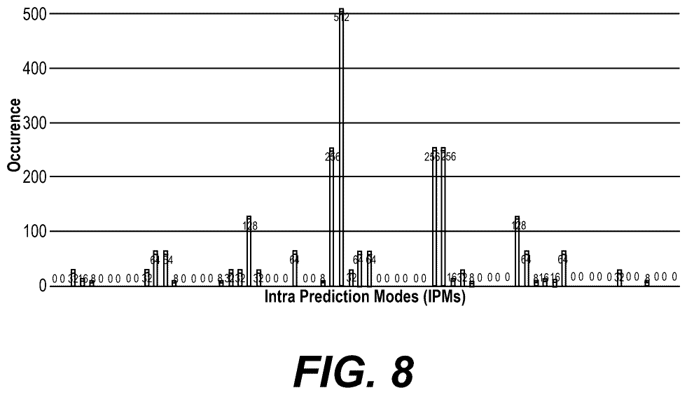

FIG. 8 shows a diagram of a HoC of intra prediction modes (also referred to as intra modes) in the spatial neighborhood of a current block in an example.

In some examples, based on the HoC, up to five angular modes with the highest occurrence values along with the planar mode or block vector based prediction are selected from the HoC. In an example, the up to six (e.g., up to five angular modes and one non-angular mode) predictors are used for deriving a final prediction (also referred to as final predictor) by blending the predictions of the selected mode predictors (e.g., predictors according to the up to five angular modes and one non-angular mode).

In some aspects, an intra mode can be used to determine a transform kernel set. In the examples of HoC, HoC can provide more than one intra modes that are used to derive the final predictor. In some examples, directly using the highest occurrence intra mode may not be able to select the optimal transform kernel set.

Aspects of the disclosure provide techniques to select transform kernel set when occurrence based intra coding (e.g., occurrence based DIMD) is used.

In some aspects, multiple transform kernel sets can be used for a coding block applied with the occurrence-based prediction. In some examples, the applied transform kernel set (in encoding/decoding) can be determined by a pre-defined or derived intra modes.

In some examples, the transform kernel sets and intra modes can have a one-to-one mapping. When an intra mode is determined, the transform kernel set that maps to the intra mode according to the one-to-one mapping can be selected for encoding/decoding the current block. In an example, the selected transform kernel set according to the mapping can include a plurality of transform kernels, and a transform kernel can be selected from the transform kernel set to perform transform/inverse transform of residual signals between the spatial domain and the frequency domain (also referred to as transform domain).

According to an aspect of the disclosure, various techniques can be used to select a transform kernel set based on the HoC.

In a first selection example, the highest angular mode (e.g., angular mode with the highest occurrence value) in the HoC is used to determine the applied transform kernel set (for encoding/decoding) from the multiple transform kernel sets. When there are multiple angular modes have the equal highest HoC, one of the equal highest intra modes is used.

In a second selection example, the second highest angular mode (e.g., angular mode with the second highest occurrence value) in the HoC is used to determine the applied transform kernel set (for encoding/decoding). When there are multiple angular modes have the equal second highest occurrence value in the HoC, one of the angular modes having the equal second highest occurrence value is used.

In a third selection example, an occurrence threshold is defined and one intra mode with a higher occurrence than the occurrence threshold in the HoC is used to determine the applied transform kernel set (for encoding/decoding).

In a fourth selection example, the planar mode is used to determine the applied transform kernel set. The planar mode is predefined to be the intra mode to select the transform kernel set for encoding/decoding.

In a fifth selection example, an offset is added to the highest angular mode (e.g., angular mode with the highest occurrence value in HoC) in the HoC and the derived new intra mode is used to determine the applied transform kernel set. For example, a first angular mode in the HoC has the highest occurrence value, and an offset (e.g., non zero integer value) is added to the first angular mode to derive a second intra mode, the second intra mode is then used to select a transform kernel set according to the one-to-one mapping. Further, a transform kernel can be selected the transform kernel set for encoding/decoding of the current block.

In some examples, there are two transform kernel sets for encoding/decoding, the two transform kernel sets are referred to as two candidate sets. The two candidate sets are determined based on one combination of two intra modes that are used in the above five selection examples. For example, a first intra mode is determined according to the first example, and a second intra mode is determined according to the fifth example. Then, the first intra mode and the second intra mode are used to determine two candidate transform kernel sets. The two candidate transform kernel sets are used for encoding/decoding of the current block.

In some examples, a most probable transform kernel (set) candidate list can be constructed based on the HoC. In an example, when the size of list is five, five transform kernel sets are considered as candidates based on the HoC. For example, five intra modes can be determined based on HoC. Then, five transform kernel sets can be determined based on the five intra modes according to the one-to-one mapping, and are used to construct the most portable transform kernel (set) candidate list.

In some examples, a syntax is signaled in the bitstream to indicate which transform kernel set (from two or more candidate transform kernel sets) is used.

In an example of two candidate transform kernel sets, a flag (e.g., one-bit) is signaled. For example, when the flag equals to 0, the first transform kernel set in the two candidate transform kernel sets is used for encoding/decoding of the current block. When the flag equals to 1, the second kernel set in the two candidate transform kernel sets is used for encoding/decoding of the current block.

In some examples, the HoC based transform kernel set selection techniques can be restricted by other coding information. In an example, the HoC based transform kernel set selection techniques are applied only for large blocks with more than 64 samples. In another example, the HoC based transform kernel set selection techniques can be applied only for the luma components. In another example, the HoC based transform kernel set selection techniques can be applied only for specific slice type (e.g., I slices).

In some examples, there are three (candidate) transform kernel sets and the three candidate transform kernel sets are determined based on a combination of three intra modes that are respectively selected according the five selection examples.

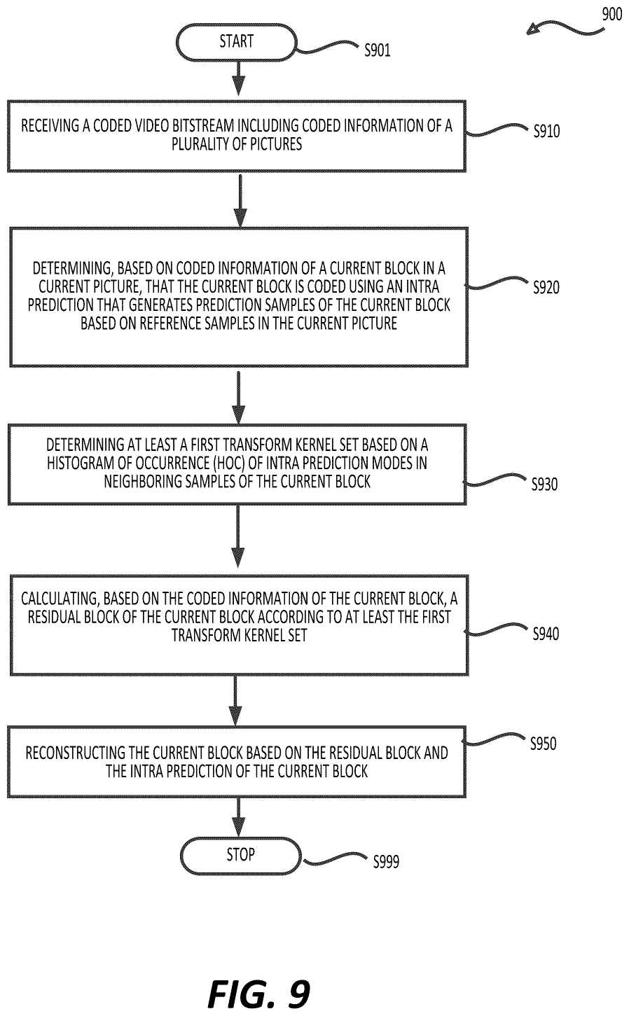

FIG. 9 shows a flow chart outlining a process (900) according to an aspect of the disclosure. The process (900) can be used in a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), a coded video bitstream is received. The coded video bitstream includes coded information of a plurality of pictures.

At (S920), based on coded information of a current block in a current picture, it is determined that the current block is coded using an intra prediction that generates prediction samples of the current block based on reference samples in the current picture.

At (S930), at least a first transform kernel set is determined based on a histogram of occurrence (HoC) of intra prediction modes in neighboring samples of the current block.

At (S940), based on the coded information of the current block, a residual block of the current block is calculated according to at least the first transform kernel set.

At (S950), the current block is reconstructed based on the residual block and the intra prediction of the current block.

In some aspects, to determine at least the first transform kernel set, at least a first intra prediction mode is determined based on the HoC of the intra prediction modes in the neighboring samples of the current block. According to a one-to-one mapping of the intra prediction modes to transform kernel sets, the first transform kernel set that maps to the first intra prediction mode is determined.

In some examples, the first intra prediction mode has a highest occurrence in the intra prediction modes of the HoC.

In some examples, the first intra prediction mode has a second highest occurrence in the intra prediction modes of the HoC.

In some examples, the first intra prediction mode has an occurrence value higher than an occurrence threshold according to the HoC.

In some examples, the first intra prediction mode is a planar mode that is predefined.

In some examples, a highest occurrence mode that has a highest occurrence in the intra prediction modes of the HoC is determined. The first intra prediction mode is determined by applying an offset to the highest occurrence mode.

In some aspects, to determine at least the first transform kernel set, at least a first intra prediction mode and a second intra prediction mode are determined based on the HoC of the intra prediction modes in the neighboring samples of the current block. According to a one-to-one mapping of intra prediction modes to transform kernel sets, the first transform kernel set and a second transform kernel that respectively map to the first intra prediction mode and the second intra prediction mode are determined.

In some aspects, to determine at least the first transform kernel set, a most probable transform kernel candidate list that includes a plurality of transform kernel sets is constructed based on the HoC of the intra prediction modes in the neighboring samples of the current block.

In some examples, a syntax element is decoded from the coded information of the current block, the syntax element indicates a selected transform kernel set from at least the first transform kernel set, the selected transform kernel set is then used for the calculating of the residual block of the current block.

In an example, when a size of the current block is larger than a threshold size, the HoC is used to determine at least the first transform kernel set.

In another example, when the current block is a luma block, the HoC is used to determine at least the first transform kernel set.

In another example, when the current block is in a specific type of slice (e.g., I slice), the HoC is used to determine at least the first transform kernel set.

Then, the process proceeds to (S999) and terminates.

The process (900) can be suitably adapted. Step(s) in the process (900) can be modified and/or omitted. Additional step(s) can be added. Any suitable order of implementation can be used.

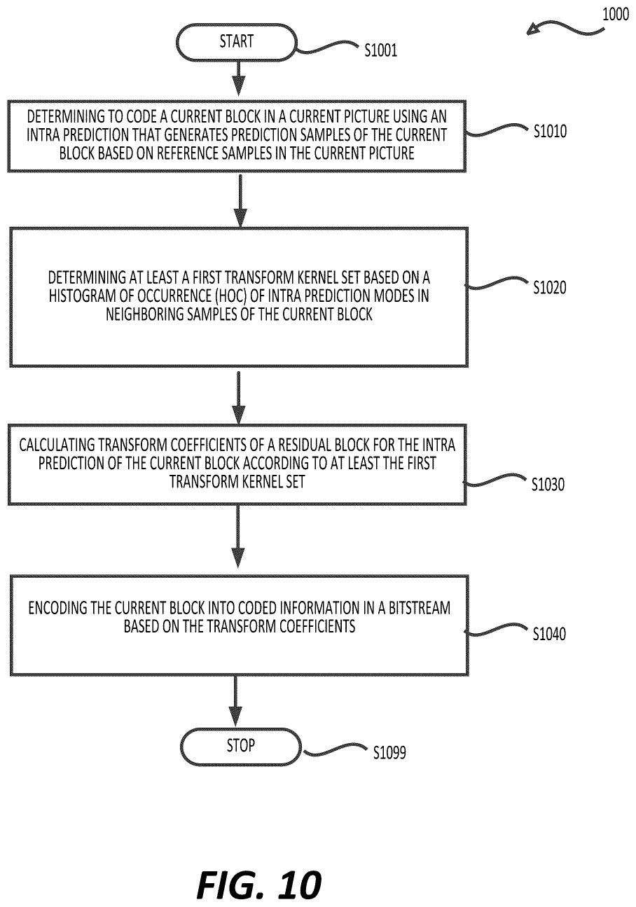

FIG. 10 shows a flow chart outlining a process (1000) according to an aspect of the disclosure. The process (1000) can be used in a video encoder. In various aspects, the process (1000) is executed by processing circuitry, such as the processing circuitry that performs functions of the video encoder (103), the processing circuitry that performs functions of the video encoder (303), and the like. In some aspects, the process (1000) is implemented in software instructions, thus when the processing circuitry executes the software instructions, the processing circuitry performs the process (1000). The process starts at (S1001) and proceeds to (S1010).

At (S1010), to code a current block in a current picture using an intra prediction is determined. The intra prediction generates prediction samples of the current block based on reference samples in the current picture.

At (S1020), at least a first transform kernel set is determined based on a histogram of occurrence (HoC) of intra prediction modes in neighboring samples of the current block.

At (S1030), transform coefficients of a residual block for the intra prediction of the current block are calculated according to at least the first transform kernel set.

At (S1040), the current block is encoded into coded information in a bitstream based on the transform coefficients.

In some aspects, to determine at least the first transform kernel set, at least a first intra prediction mode is determined based on the HoC of the intra prediction modes in the neighboring samples of the current block. According to a one-to-one mapping of the intra prediction modes to transform kernel sets, the first transform kernel set that maps to the first intra prediction mode is determined.

In some examples, the first intra prediction mode has a highest occurrence in the intra prediction modes of the HoC.

In some examples, the first intra prediction mode has a second highest occurrence in the intra prediction modes of the HoC.

In some examples, the first intra prediction mode has an occurrence value higher than an occurrence threshold according to the HoC.

In some examples, the first intra prediction mode is a planar mode that is predefined.

In some examples, a highest occurrence mode that has a highest occurrence in the intra prediction modes of the HoC is determined. The first intra prediction mode is determined by applying an offset to the highest occurrence mode.

In some aspects, to determine at least the first transform kernel set, at least a first intra prediction mode and a second intra prediction mode are determined based on the HoC of the intra prediction modes in the neighboring samples of the current block. According to a one-to-one mapping of intra prediction modes to transform kernel sets, the first transform kernel set and a second transform kernel that respectively map to the first intra prediction mode and the second intra prediction mode are determined.

In some aspects, to determine at least the first transform kernel set, a most probable transform kernel candidate list that includes a plurality of transform kernel sets is constructed based on the HoC of the intra prediction modes in the neighboring samples of the current block.

In some examples, a selected transform kernel set by the encoder is used for the calculating of the residual block of the current block, and a syntax element is encoded into the coded information into the bitstream, the syntax element indicates the selected transform kernel set from at least the first transform kernel set.

In an example, when a size of the current block is larger than a threshold size, the HoC is used to determine at least the first transform kernel set.

In another example, when the current block is a luma block, the HoC is used to determine at least the first transform kernel set.

In another example, when the current block is in a specific type of slice (e.g., I slice), the HoC is used to determine at least the first transform kernel set.

Then, the process proceeds to (S1099) and terminates.

The process (1000) can be suitably adapted. Step(s) in the process (1000) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that a current block in a current picture is coded using an intra prediction that generates prediction samples of the current block based on reference samples in the current picture. The format rule also specifies that at least a first transform kernel set is determined based on a histogram of occurrence (HoC) of intra prediction modes in neighboring samples of the current block, a residual block of the current block is calculated according to at least the first transform kernel set and the current block is reconstructed based on the residual block and the intra prediction of the current block.

Some aspects of the disclosure provide techniques to select transform kernel set when intra block copy (IBC) is applied on a current block.

According to an aspect of disclosure, intra block copy (IBC) is a coding tool that is efficient for screen content. In some examples, for a coding block in the IBC mode, a reference block in a pre-defined reconstructed area can be found with a signaled block vector. The reference block can be copied to the current block as the prediction signal. There are some variations of the IBC mode. In an example, more than one block vectors can be signaled, and the final predictor is a weighted fusion of individual predictors pointed to respectively by signaled block vectors.

The block vector in IBC mode can have precision in full-pel, 4-pel or fractional pel precision. In some examples, using fractional block vector (e.g. half-pel or quarter-pel) and appropriate interpolation filter, IBC can be an effective coding mode for natural camera-captured content.

In some video codecs (e.g., VVC), IBC mode is treated as a third prediction mode in addition to the intra prediction and inter prediction. In some examples, at the transform stage, however, the transform kernel selection is quite limited for IBC blocks. For example, only DCT2 transform kernel is allowed for the primary transform and no secondary transform kernel can be applied. Such limitation in the transform stage for IBC can hinder coding performance.

Some aspects of the present disclosure provide selection techniques of transform kernel set for IBC mode, and can improve coding performance.

According to some aspects of the disclosure, a set (also referred to as a transform kernel set) of primary and/or secondary transform kernels that are allowed for blocks coding with IBC mode can be predefined. Further, one or more syntax element(s) can be signaled or derived to select the primary and/or secondary transform kernel from the set to apply on one or more blocks in the IBC mode.

In some examples, the application of multiple primary and/or secondary transforms is used only for the IBC blocks having natural camera-captured content.

In some examples, the application of a transform kernel indicates a forward transform at the encoder side and a corresponding inverse transform at the decoder side.

In some examples, the allowed primary transform kernel includes but not limits to: {DCT2, DCT8, DST7, DCT5, DST4, DST1}.

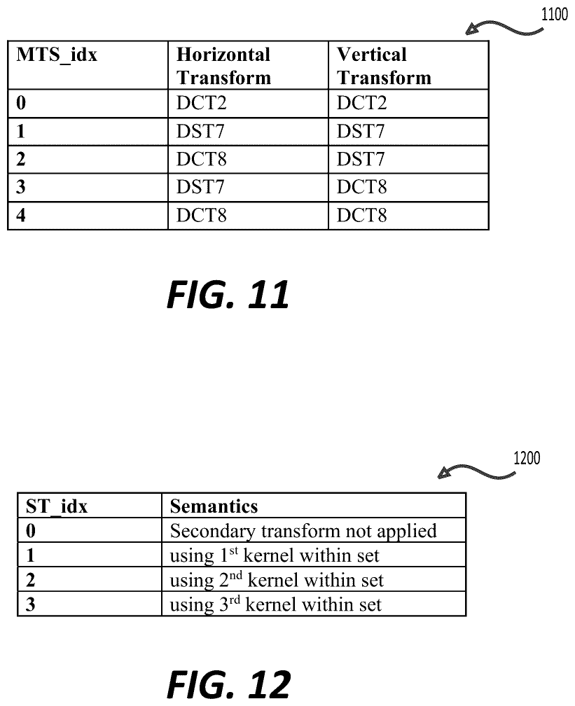

In some examples, the allowed primary transform kernel(s) can be separately applied for a block with horizontal and vertical transforms, respectively. In an example, a multiple transform selection (MTS) index is signaled to indicate which combination of primary transforms (respectively for the horizontal transform and the vertical transform) is applied. FIG. 11 shows a table (1100) of using MTS index (MTS_idx) to indicate a selection of primary transform kernels for horizontal transform and vertical transform in an example.

In some examples, the allowed secondary transform kernels are non-separable transform kernels and are organized hierarchically with two layers, such as a first layer of transform kernel set and a second layer of transform kernel within each set. Further, the selection of the secondary transform kernel depends on the transform kernel set information and the selection of transform kernel within the kernel set.

In an example, the secondary transform kernel set information is derived based on intra prediction mode using a pre-defined mapping table.

In another example, the secondary transform kernel set information is derived based on intra prediction mode and an explicitly signaled syntax element. Depending on the intra prediction mode, the signaled syntax element indicates other alternative secondary transform set that could be used.

In another example, the intra mode information for the IBC block is derived based on the prediction signal of the current block. The intra mode derivation process analyzes the gradient of the predicted signal first, and then ranks the gradient in a histogram. The most frequent gradient in the histogram is picked up and corresponds to a specific intra mode.

In another example, the secondary transform kernel within a kernel set is signaled by a secondary transform index (ST_idx). FIG. 12 shows a table (1200) of using a secondary transform index to indicate a secondary transform kernel that is selected from a transform kernel set having three kernels in an example.

In some examples, the application of primary transform and secondary transform are conditionally exclusive. In an example, the application of secondary transform is allowed only with DCT2 primary transform, for example when MTS_idx is equal to 0. In another example, the application of primary transforms other than DCT2 is allowed only when secondary transforms is disabled, for example when ST_idx is equal to 0.

In some examples, the application of multiple primary and/or secondary transform depends on other codec information, such as coding block position and size, slice type, partition scheme, is luma or chroma component, etc.

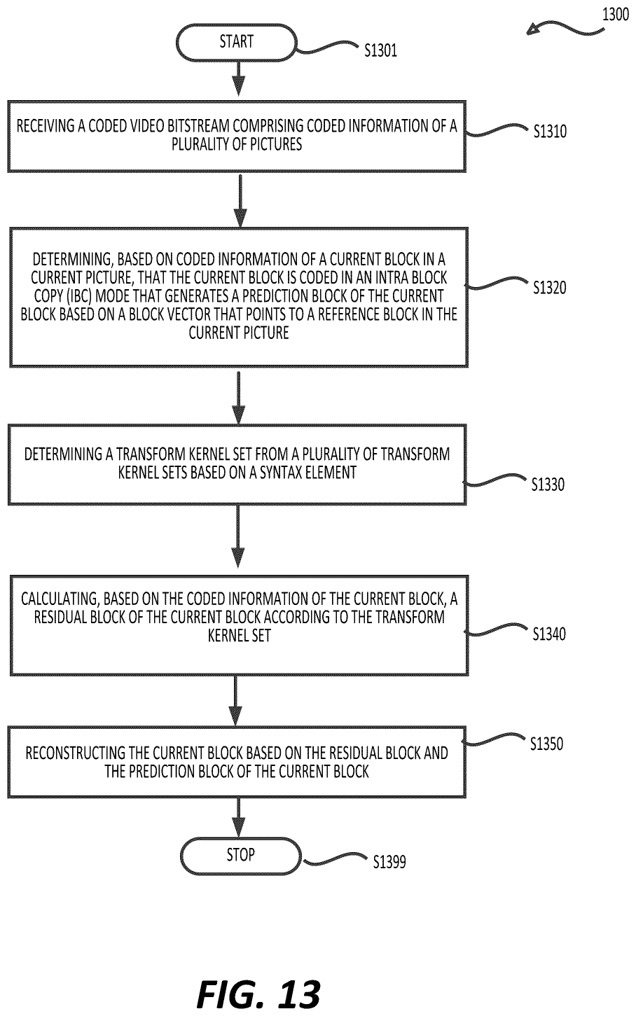

FIG. 13 shows a flow chart outlining a process (1300) according to an aspect of the disclosure. The process (1300) can be used in a video decoder. In various aspects, the process (1300) is executed by processing circuitry, such as the processing circuitry that performs functions of the video decoder (110), the processing circuitry that performs functions of the video decoder (210), and the like. In some aspects, the process (1300) is implemented in software instructions, thus when the processing circuitry executes the software instructions, the processing circuitry performs the process (1300). The process starts at (S1301) and proceeds to (S1310).

At (S1310), a coded video bitstream is received. The coded video bitstream includes coded information of a plurality of pictures.

At (S1320), based on coded information of a current block in a current picture, it is determined that the current block is coded in an intra block copy (IBC) mode that generates a prediction block of the current block based on a block vector that points to a reference block in the current picture.

At (S1330), a transform kernel set is determined from a plurality of transform kernel sets based on a syntax element.

At (S1340), based on the coded information of the current block, a residual block of the current block is calculated according to the transform kernel set.

At (S1350), the current block is reconstructed based on the residual block and the prediction block of the current block.

Then, the process proceeds to (S1399) and terminates.

The process (1300) can be suitably adapted. Step(s) in the process (1300) can be modified and/or omitted. Additional step(s) can be added. Any suitable order of implementation can be used.

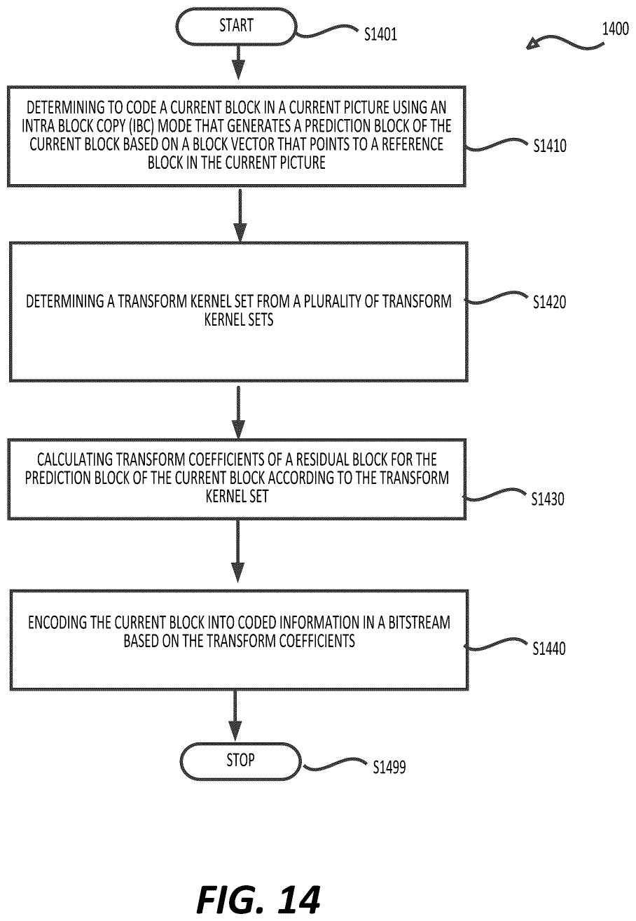

FIG. 14 shows a flow chart outlining a process (1400) according to an aspect of the disclosure. The process (1400) can be used in a video encoder. In various aspects, the process (1400) is executed by processing circuitry, such as the processing circuitry that performs functions of the video encoder (103), the processing circuitry that performs functions of the video encoder (303), and the like. In some aspects, the process (1400) is implemented in software instructions, thus when the processing circuitry executes the software instructions, the processing circuitry performs the process (1400). The process starts at (S1401) and proceeds to (S1410).

At (S1410), to code a current block in a current picture using an intra block copy (IBC) mode is determined. Using the IBC mode, a prediction block of the current block is generated based on a block vector that points to a reference block in the current picture.

At (S1420), a transform kernel set is determined (selected) from a plurality of transform kernel sets.

At (S1430), transform coefficients of a residual block for the prediction block of the current block are calculated according to the transform kernel set.

At (S1440), the current block is encoded into coded information in a bitstream based on the transform coefficients. In some examples, a syntax element indicating the selected transform kernel set from the plurality of transform kernel sets can be encoded into the bitstream. In another example, the syntax element is derivable, and is not signaled in the bitstream.

Then, the process proceeds to (S1499) and terminates.

The process (1400) can be suitably adapted. Step(s) in the process (1400) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that, based on coded information of a current block in a current picture, the current block is determined in an intra block copy (IBC) mode that generates a prediction block of the current block based on a block vector that points to a reference block in the current picture. The format rule also specifies that a transform kernel set is selected from a plurality of transform kernel sets based on a syntax element. Further, the format rule specifies that based on the coded information of the current block, a residual block of the current block is calculated according to the transform kernel se, and the current block is reconstructed based on the residual block and the prediction block of the current block.

Some aspects of the disclosure provide techniques for transform kernel set selection for intra prediction modes in video coding.

It is noted that many types of transform kernels can be used in some video codecs. For example, the transform kernel can be derived from the discrete cosine transform (DCT) or discrete sine transform (DST) family. The transform kernels can also be derived using optimization and data driven approaches (e.g., non-separable primary transform (NSPT)). Multiple stages of transform can also be used to improve the energy compactness of the transform coefficients (e.g., low-frequency non-separable transform (LFNST)). A coding block can typically choose an appropriate transform from a set of transform kernel candidates.

In some examples, the residual signals (e.g., residual blocks) resulted from a particular intra prediction mode can share similar pattern. Therefore, specific transform kernels leveraging such patterns can be selected for the intra prediction mode to improve the energy compactness.

Some aspects of the disclosure provide transform kernel selection techniques in intra prediction. The intra prediction can include two types of intra prediction signals: block vector based prediction signals and fusion prediction signals. In the block vector based prediction signals, the prediction signal is generated from a reference block specified by the block vector. In the fusion prediction signals, the final prediction signal is blended from multiple prediction signals (also referred to as prediction signal components) with given weights for respect prediction signal components.

In some aspects, when the intra prediction signal is generated using block vector based intra prediction method, the transform kernel selection information is inherited from the reference block specified by the block vector.

In some examples, one or more transform kernel candidates can be inherited from the reference block. The transform kernel that is used (in encoding/decoding) can be either signaled or derived from the one or more transform kernel candidates.

In an example, the one or more transform candidates that are inherited from a block that includes the location of one of the corners (i.e., top-left, top-right, bottom-left, bottom-right) of the current block displaced by the block vector. For example, the block vector points to a reference block of the current block in the same picture. In an example, the reference block has a top-left corner that belongs to a coding block, and the one or more transform candidates to code the current block can be inherited from the coding block. In another example, the reference block has a top-right corner that belongs to a coding block, and the one or more transform candidates to code the current block can be inherited from the coding block. In another example, the reference block has a bottom-left corner that belongs to a coding block, and the one or more transform candidates to code the current block can be inherited from the coding block. In another example, the reference block has a bottom-right corner that belongs to a coding block, and the one or more transform candidates to code the current block can be inherited from the coding block.

In another example, the transform candidates are inherited from the block that contains the location of the center of the current block displaced by the block vector. For example, the reference block has a center position that belongs to a coding block, and the one or more transform candidates to code the current block can be inherited from the coding block.

It is noted that, in some examples, the block vector based intra prediction method can be intra template matching (IntraTMP); and in some examples, the block vector based intra prediction methods can be intra block copy (IBC).

It is noted that, in an aspect, the technique to inherit the transform kernel selection information from the reference block specified by the block vector can be applied to transform kernel selection in primary transform, which includes but is not limited to, multiple transform selection (MTS) and NSPT.

It is noted that, in an aspect, the technique to inherit the transform kernel selection information from the reference block specified by the block vector can be applied to transform kernel selection in secondary transform, which includes but is not limited to, LFNST.

In some aspects, when the intra prediction signal is generated using fusion based intra prediction method, the transform kernel selection process can leverage the information from the prediction signal components used to generate the fusion prediction signal.

In some examples, when fusion based intra prediction method is used, one or more transform kernel candidates are provided. The transform kernel used (for encoding/decoding) is either signaled or derived from the one or more transform kernel candidates.

In some examples, when fusion based intra prediction method is used, one or more transform kernel candidates are determined by analyzing the prediction signal components used to generate the fusion prediction signal. For example, (the entirety or a part of) the transform kernel candidates are inherited from the ones associated with a fusion component (prediction signal component) with the highest fusion weight. The transform kernel used (in encoding/decoding) is either signaled or derived from the transform kernel candidates.

In some examples, when fusion based intra prediction method is used, the one or more transform kernel candidates are determined by analyzing the prediction signal components used to generate the fusion prediction signal. For example, when the fusion components (prediction signal components) include 1) only angle intra prediction signals; 2) only non-angle intra prediction signals; 3) both angle and non-angle intra prediction signals, then dedicated transform kernel candidates are provided for each of the scenario, respectively. The transform kernel used (in encoding/decoding) is either signaled or derived from the transform kernel candidates.

In some examples, when fusion based intra prediction method is used, the one or more transform kernel candidates are determined by analyzing the prediction signal components used to generate the fusion prediction signal. For example, when the fusion components (prediction signal components) include block vector based intra prediction method, then (the entirety or a part of) the transform kernel candidates are inherited from the reference block. The transform kernel used (in encoding/decoding) is either signaled or derived from these candidates.

In some examples, the fusion weights can be used to reorder the transform kernel candidates.

In some examples, the fusion weights can be used to derive the probabilities of the syntax elements used to signal the selected transform candidate (in encoding/decoding).

In some examples, the fusion based intra prediction method is intra prediction fusion.

In some examples, the fusion based intra prediction method is template-based intra mode derivation (TIMD).

In some examples, the fusion based intra prediction method is decoder-side intra mode derivation (DIMD).

In some examples, the technique to perform the transform kernel selection based on prediction signal components of the fusion based intra prediction can be applied to transform kernel selection in primary transform, which includes but is not limited to, multiple transform selection (MTS) and NSPT.

In one example, the technique to perform the transform kernel selection based on prediction signal components of the fusion based intra prediction can be applied to transform kernel selection in secondary transform, which includes but is not limited to, LFNST.

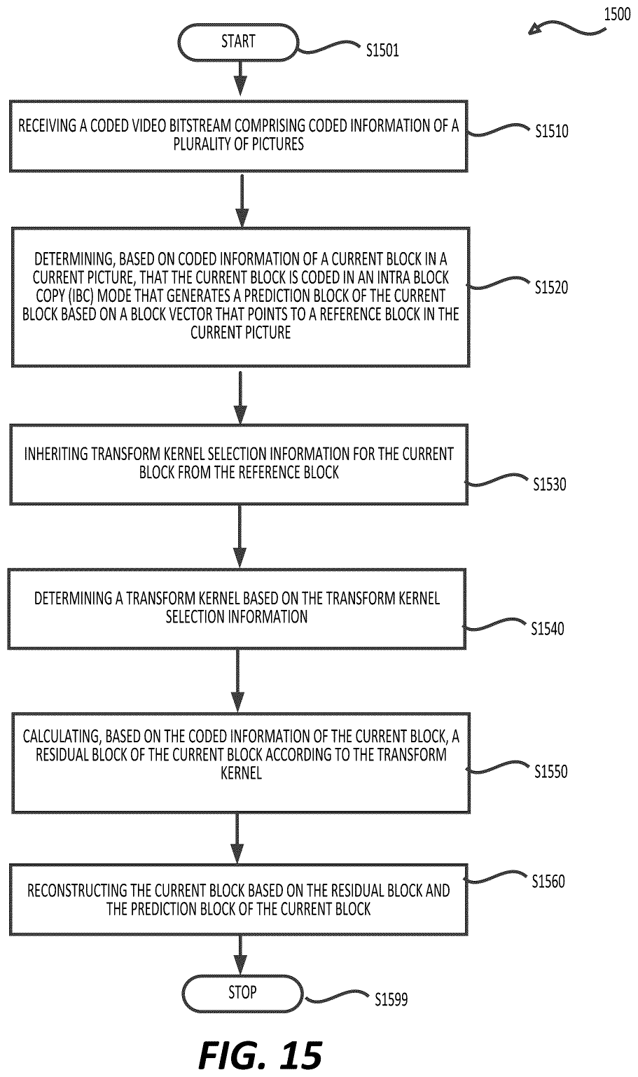

FIG. 15 shows a flow chart outlining a process (1500) according to an aspect of the disclosure. The process (1500) can be used in a video decoder. In various aspects, the process (1500) is executed by processing circuitry, such as the processing circuitry that performs functions of the video decoder (110), the processing circuitry that performs functions of the video decoder (210), and the like. In some aspects, the process (1500) is implemented in software instructions, thus when the processing circuitry executes the software instructions, the processing circuitry performs the process (1500). The process starts at (S1501) and proceeds to (S1510).

At (S1510), a coded video bitstream is received. The coded video bitstream includes coded information of a plurality of pictures.

At (S1520), based on coded information of a current block in a current picture, it is determined that the current block is coded in an intra block copy (IBC) mode that generates a prediction block of the current block based on a block vector that points to a reference block in the current picture.

At (S1530), transform kernel selection information for the current block is inherited from the reference block.

At (S1540), a transform kernel is determined based on the transform kernel selection information.

At (S1550), a residual block of the current block is calculated according to the transform kernel and the coded information of the current block.

At (S1560), the current block is reconstructed based on the residual block and the prediction block of the current block.

Then, the process proceeds to (S1599) and terminates.

The process (1500) can be suitably adapted. Step(s) in the process (1500) can be modified and/or omitted. Additional step(s) can be added. Any suitable order of implementation can be used.

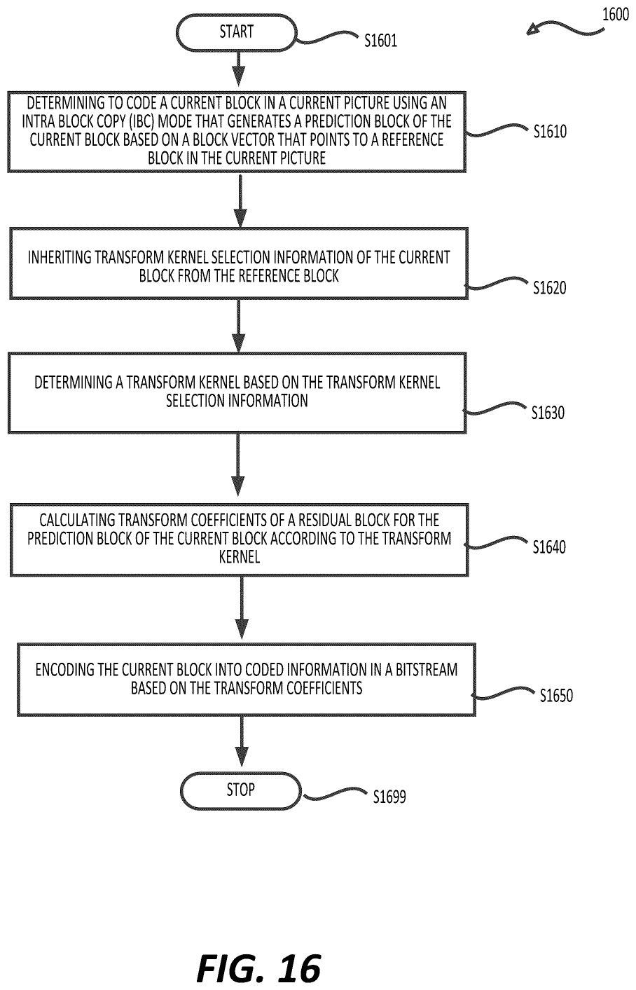

FIG. 16 shows a flow chart outlining a process (1600) according to an aspect of the disclosure. The process (1600) can be used in a video encoder. In various aspects, the process (1600) is executed by processing circuitry, such as the processing circuitry that performs functions of the video encoder (103), the processing circuitry that performs functions of the video encoder (303), and the like. In some aspects, the process (1600) is implemented in software instructions, thus when the processing circuitry executes the software instructions, the processing circuitry performs the process (1600). The process starts at (S1601) and proceeds to (S1610).

At (S1610), to code a current block in a current picture using an intra block copy (IBC) mode is determined. Using the IBC mode can generate a prediction block of the current block based on a block vector that points to a reference block in the current picture.

At (S1620), transform kernel selection information for the current block is inherited from the reference block.

At (S1630), a transform kernel is determined based on the transform kernel selection information.

At (S1640), transform coefficients of a residual block for the prediction block of the current block are calculated according to the transform kernel.

At (S1650), the current block is encoded into coded information in a bitstream based on the transform coefficients.

Then, the process proceeds to (S1699) and terminates.

The process (1600) can be suitably adapted. Step(s) in the process (1600) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that, based on coded information of a current block in a current picture, the current block is determined in an intra block copy (IBC) mode that generates a prediction block of the current block based on a block vector that points to a reference block in the current picture. Further, the format rule specifies that transform kernel selection information of the current block is inherited from the reference block, a transform kernel is determined based on the transform kernel selection information, based on the coded information of the current block, a residual block of the current block is calculated according to the transform kernel; and the current block is reconstructed based on the residual block and the prediction block of the current block.

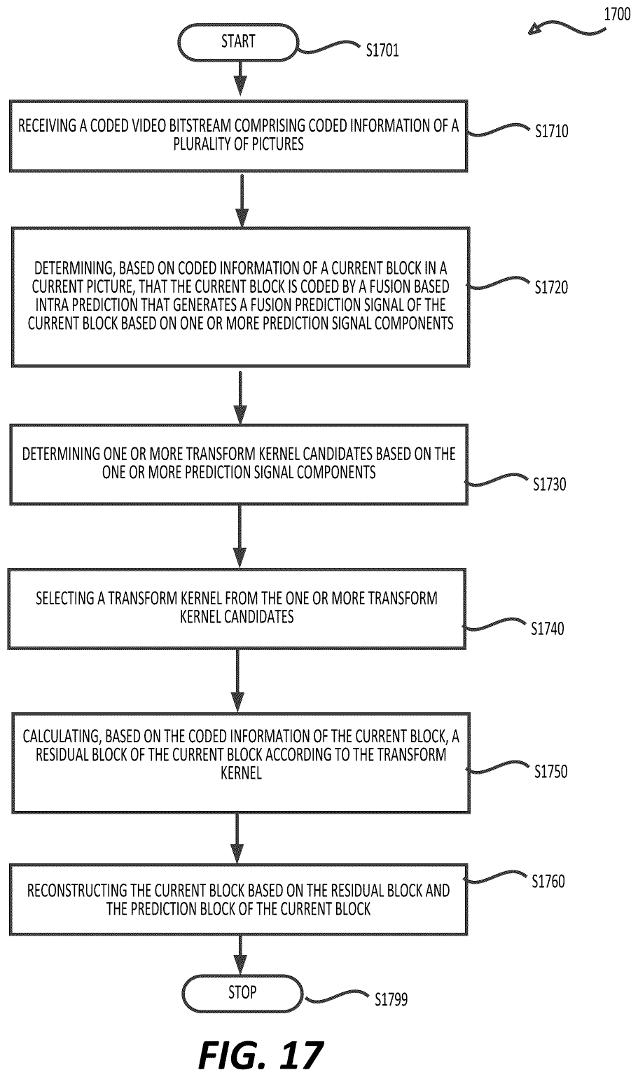

FIG. 17 shows a flow chart outlining a process (1700) according to an aspect of the disclosure. The process (1700) can be used in a video decoder. In various aspects, the process (1700) is executed by processing circuitry, such as the processing circuitry that performs functions of the video decoder (110), the processing circuitry that performs functions of the video decoder (210), and the like. In some aspects, the process (1700) is implemented in software instructions, thus when the processing circuitry executes the software instructions, the processing circuitry performs the process (1700). The process starts at (S1701) and proceeds to (S1710).

At (S1710), a coded video bitstream is received. The coded video bitstream includes coded information of a plurality of pictures.

At (S1720), based on coded information of a current block in a current picture, it is determined that the current block is coded by a fusion based intra prediction that generates a fusion prediction signal of the current block based on one or more prediction signal components.

At (S1730), one or more transform kernel candidates are determined based on the one or more prediction signal components. In an example, the one or more transform kernel candidates form a transform kernel set.

At (S1740), a transform kernel is selected from the one or more transform kernel candidates.

At (S1750), based on the coded information of the current block, a residual block of the current block is calculated according to the transform kernel.

At (S1760), the current block is reconstructed based on the residual block and the prediction block of the current block.

Then, the process proceeds to (S1799) and terminates.

The process (1700) can be suitably adapted. Step(s) in the process (1700) can be modified and/or omitted. Additional step(s) can be added. Any suitable order of implementation can be used.

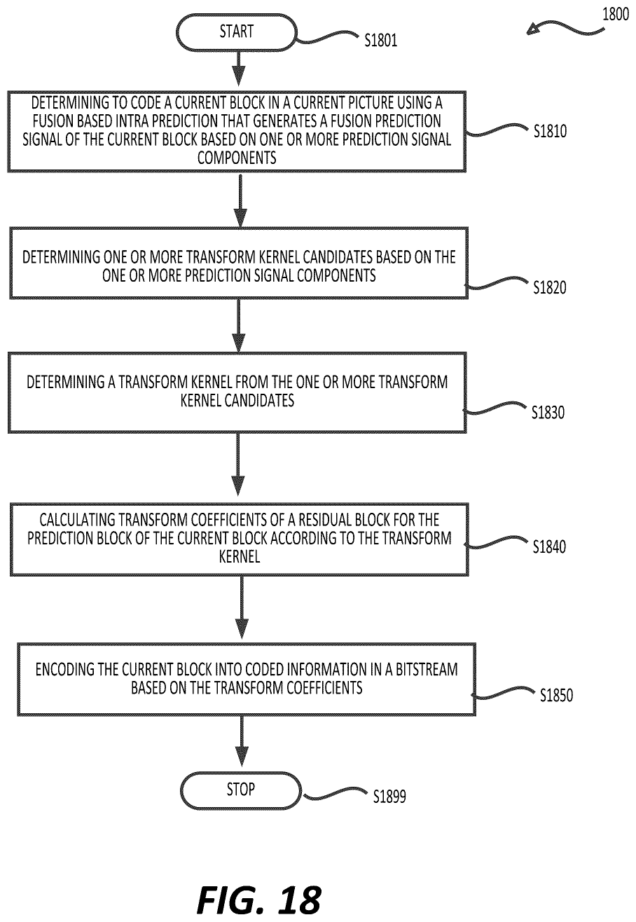

FIG. 18 shows a flow chart outlining a process (1800) according to an aspect of the disclosure. The process (1800) can be used in a video encoder. In various aspects, the process (1800) is executed by processing circuitry, such as the processing circuitry that performs functions of the video encoder (103), the processing circuitry that performs functions of the video encoder (303), and the like. In some aspects, the process (1800) is implemented in software instructions, thus when the processing circuitry executes the software instructions, the processing circuitry performs the process (1800). The process starts at (S1801) and proceeds to (S1810).

At (S1810), to code a current block in a current picture using a fusion based intra prediction is determined. The fusion based intra prediction can generate a fusion prediction signal of the current block based on one or more prediction signal components.

At (S1820), one or more transform kernel candidates are determined based on the one or more prediction signal components.

At (S1830), a transform kernel is determined from the one or more transform kernel candidates.

At (S1840), transform coefficients of a residual block for the prediction block of the current block are calculated according to the transform kernel.

At (S1850), the current block is encoded into coded information in a bitstream based on the transform coefficients.

Then, the process proceeds to (S1899) and terminates.

The process (1800) can be suitably adapted. Step(s) in the process (1800) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that, based on coded information of a current block in a current picture, it is determined that the current block is coded by a fusion based intra prediction that generates a fusion prediction signal of the current block based on one or more prediction signal components. The format rule also specifies that one or more transform kernel candidates are determined based on the one or more prediction signal components; a transform kernel is selected from the one or more transform kernel candidates; based on the coded information of the current block, a residual block of the current block is calculated according to the transform kernel; and the current block is reconstructed based on the residual block and the prediction block of the current block.

Some aspects of the disclosure provide techniques for adaptive multi-transform set selection.

In some examples, non-separable transform can include multiple transform kernel sets. A transform kernel set can be selected based on a prediction mode, such as intra (prediction) mode. To provide diversity in transform (kernel) set selection, multiple transform (kernel) set candidates can be given for a current prediction mode with an offset.

Some aspects of the present disclosure provide techniques to select an appropriate set of transform kernels based on the prediction information.

In some aspects, a transform set index (of a transform set to be used in encoding/decoding) is determined by a set index and an offset, such as represented by (set_index+set_offset). In some examples, the offset is adaptively adjusted. The transform set index is used to select one or more transform sets for primary transform and/or secondary transform.

In an aspect, the number of transform sets (denoted by N) can be any positive integer over 0, such as 1, 2, 3, and the like.

In an aspect, each transform set can have a plurality of transform kernels.

In an aspect, the transform set index can indicate a set of transform (kernel) sets.

In an aspect, the transform set index (denoted by tr_idx) can be represented by (set_index+offset).

In an aspect, set_index can be defined based on one or more of prediction information of the current block. In ab example, set_index can be determined by an intra prediction mode of the current block.

In an aspect, set_index can be defined based on one or more of prediction information of reconstructed blocks.

In an aspect, set_index can be defined based on one or more of prediction information from the current block and/or reconstructed blocks.

In an aspect, the offset can be defined using one of pre-defined offset lists and an (offset) index is signaled to indicate which offset in the pre-defined offset list (the one of pre-defined offset lists) is used. In some examples, the pre-defined offset list includes a plurality of offsets, such as {−1, 0, −1}, and the like. One of the offsets is suitably signaled.

In an aspect, an offset list can be adjustable. In some examples, the offset list can be one of {−a, 0, a}, {0, a, b}, {−b, −a, 0}, { . . . , −b, −a, 0, a, b, . . . }, etc.

In an aspect, when the offset is based on one of adjustable offset lists, the variable can be adjusted depending on one or more of prediction information from the current block and neighboring blocks.

In an example, the set_index can be determined by intra prediction mode, for example using a pre-defined look-up table. The pre-defined look-up table maps intra prediction modes to set_index values.

In an example, among the intra prediction modes, some intra prediction modes can respectively represent predictors generated using intra prediction, while some other intra prediction modes can respectively represent predictors generated by matrix-based approaches. For example, an odd intra mode number (2N+1) represents a predictor generated by intra prediction, while an even intra mode number (2N) represents a predictor generated by matrix-based approaches.

In an example, the adjustable offset list is {−a, 0, a}, the offset can be −a or a, the offset varies based on the intra prediction mode.

In an example, the current prediction mode (denoted by P) is one of intra modes and maps to set_index (P), (P−1) denotes one of matrix-based prediction modes and maps to set_index (P−1), the offset variable a can be 2, where mode (P−2) or (P+2) corresponding to intra modes. The offset is determined among {−2, 0, 2} to avoid a transform set for different intra mode characteristic.

In an example, when the current prediction mode (denoted by P) is one of matrix-based prediction modes and (P−4) or (P+4) can be another matrix-based mode, the variable a can be 4 to use a transform set for the same intra mode characteristic.

In an example, when the adjustable offset list is {a, b, c}, neighboring prediction modes (e.g., intra prediction modes of the neighboring blocks) are different with the current prediction mode, the variables (a, b, and c) can be differences between current prediction mode and neighboring prediction modes.

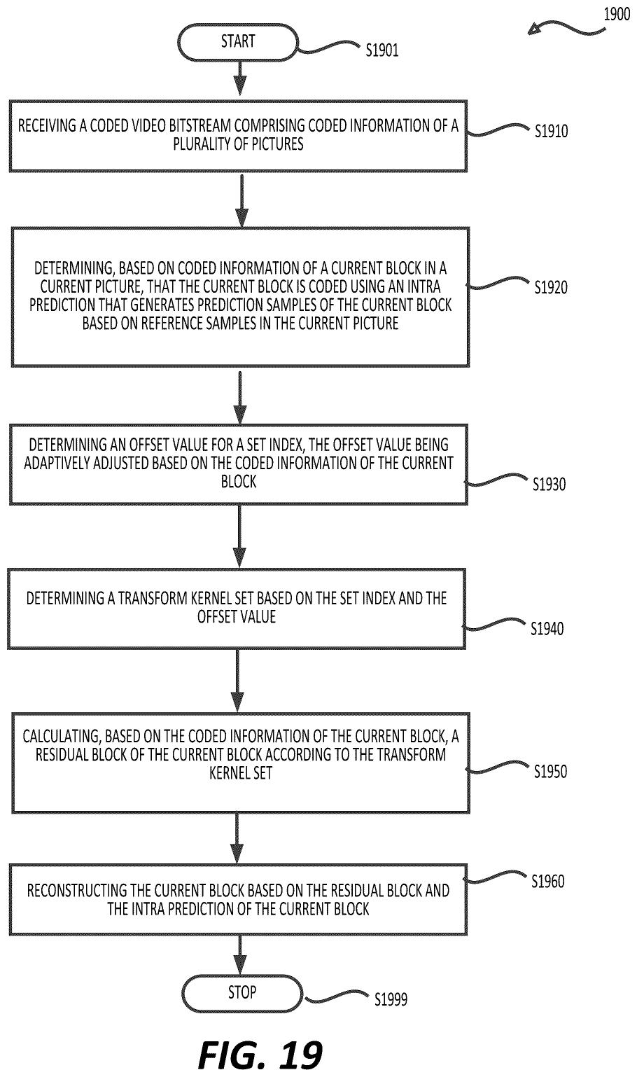

FIG. 19 shows a flow chart outlining a process (1900) according to an aspect of the disclosure. The process (1900) can be used in a video decoder. In various aspects, the process (1900) is executed by processing circuitry, such as the processing circuitry that performs functions of the video decoder (110), the processing circuitry that performs functions of the video decoder (210), and the like. In some aspects, the process (1900) is implemented in software instructions, thus when the processing circuitry executes the software instructions, the processing circuitry performs the process (1900). The process starts at (S1901) and proceeds to (S1910).

At (S1910), a coded video bitstream is received. The coded video bitstream includes coded information of a plurality of pictures.

At (S1920), based on coded information of a current block in a current picture, it is determined that the current block is coded using an intra prediction that generates prediction samples of the current block based on reference samples in the current picture.

At (S1930), an offset value for a set index is determined, the offset value is adaptively adjusted based on the coded information of the current block.

At (S1940), a transform kernel set is determined based on the set index and the offset.

At (S1950), based on the coded information of the current block, a residual block of the current block is calculated according to the transform kernel set.

At (S1960), the current block is reconstructed based on the residual block and the intra prediction of the current block.

Then, the process proceeds to (S1999) and terminates.

The process (1900) can be suitably adapted. Step(s) in the process (1900) can be modified and/or omitted. Additional step(s) can be added. Any suitable order of implementation can be used.

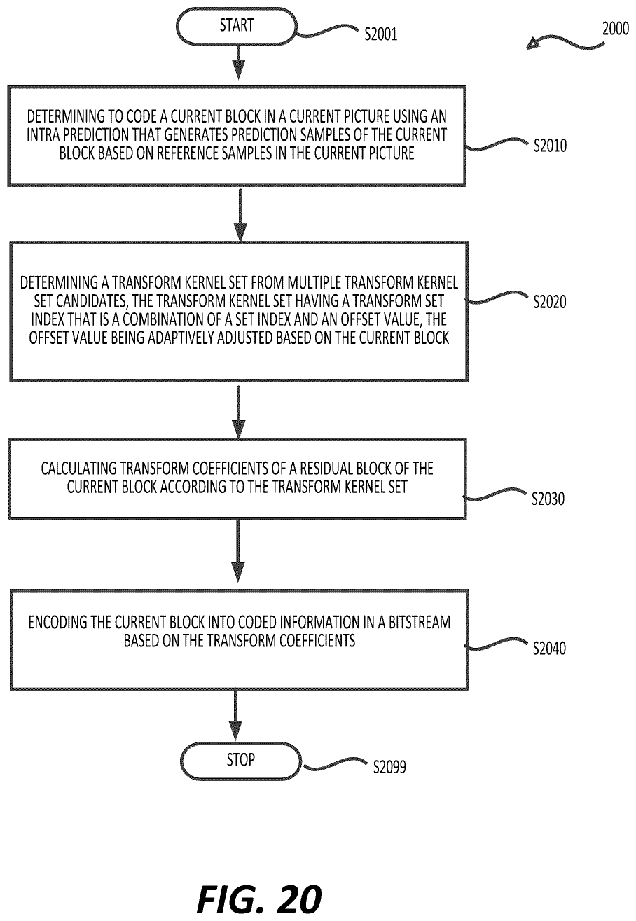

FIG. 20 shows a flow chart outlining a process (2000) according to an aspect of the disclosure. The process (2000) can be used in a video encoder. In various aspects, the process (2000) is executed by processing circuitry, such as the processing circuitry that performs functions of the video encoder (103), the processing circuitry that performs functions of the video encoder (303), and the like. In some aspects, the process (2000) is implemented in software instructions, thus when the processing circuitry executes the software instructions, the processing circuitry performs the process (2000). The process starts at (S2001) and proceeds to (S2010).

At (S2010), to code a current block in a current picture using an intra prediction that generates prediction samples of the current block based on reference samples in the current picture is determined.

At (S2020), a transform kernel set is determined (selected) from multiple transform kernel set candidates, the transform kernel set has a transform set index that is a combination of a set index and an offset value, the offset value has been adaptively adjusted based on the current block.

At (S2030), transform coefficients of a residual block of the current block are determined according to the transform kernel set.

At (S2040), the current block is encoded into coded information in a bitstream based on the transform coefficients.

Then, the process proceeds to (S2099) and terminates.

The process (2000) can be suitably adapted. Step(s) in the process (2000) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that, based on coded information of a current block in a current picture, the current block is determined to be coded using an intra prediction that generates prediction samples of the current block based on reference samples in the current picture. The format rule also specifies that an offset value for a set index is determined, the offset value being adaptively adjusted based on the coded information of the current block; a transform kernel set is selected based on the set index and the offset; based on the coded information of the current block, a residual block of the current block is calculated according to the transform kernel set; and the current block is reconstructed based on the residual block and the intra prediction of the current block.

Some aspects of the present disclosure also provide techniques for adaptive transform kernel derivation in blocks with intra and inter predicted partitions.

In some aspects, intra prediction information is available for inter coded blocks. The present disclosure provide techniques for improving transform kernel derivation based on the intra prediction mode information in inter coded block.

According to an aspect of the disclosure, intra and inter predictions can be suitably combined by coding techniques. One of the coding techniques to combine intra and inter prediction is referred to as combined inter and intra prediction (CIIP) that is also called a multi-hypothesis intra-inter prediction. For example, the CIIP can combine one intra prediction and one merge prediction. In an example, when a CU is in the merge mode, a specific flag for intra mode is signaled. When the specific flag is true, an intra mode can be selected from an intra candidate list. For luma component, the intra candidate list is derived from 4 intra prediction modes, such as DC mode, planar mode, horizontal mode, and vertical mode, and the size of the intra mode candidate list can be 3 or 4 depending on the block shape. In an example, when the CU width is larger than twice of CU height, the horizontal mode is removed from the intra mode candidate list and when the CU height is larger than twice of CU width, vertical mode is removed from the intra mode candidate list. In some embodiments, an intra prediction is performed based on an intra prediction mode selected by an intra mode index and an inter prediction is performed based on a merge index. The intra prediction and the inter prediction are combined using weighted average. For chroma component, a copy of the intra and/or inter prediction mode information from the luma component can be used without extra signaling in some examples.

In some embodiments, the weights for combining the intra prediction and the inter prediction can be suitably determined. In an example, when DC or planar mode is selected or the coding block (CB) width or height is smaller than 4, equal weights are applied for inter prediction and intra prediction. In another example, for a CB with CB width and height larger than or equal to 4, when horizontal/vertical mode is selected, the CB is first vertically/horizontally split into four equal-area regions. Each region has a weight set, denoted as (w_intra₁, w_inter₁), where i is from 1 to 4. In an example, the first weight set (w_intra₁, w_inter₁)=(6, 2), the second weight set (w_intra₂, w_inter₂)=(5, 3), the third weight set (w_intra₃, w_inter₃)=(3, 5), and fourth weight set (w_intra₄, w_inter₄)=(2, 6), can be applied to a corresponding region. For example, the first weight set (w_intra₁, w_inter₁) is for the region closest to the reference samples and fourth weight set (w_intra₄, w_inter₄) is for the region farthest away from the reference samples. Then, the combined prediction can be calculated by summing up the two weighted predictions and right-shifting 3 bits.

Moreover, the intra prediction mode for the intra hypothesis of predictors can be saved for the intra mode coding of the following neighboring CBs when the neighboring CBs are intra coded.

According to another aspect of the disclosure, an inter coded block can be partitioned into two or more partitions. The two or more partitions can be predicted by different prediction information. In an example, one partition can be predicted by inter prediction, and another partition can be predicted by intra prediction. In another example, the two or more partitions can be predicted by inter predictions of different motion information.

In some examples (e.g., VVC), a technique that is referred to as geometric partition mode (GPM) is used. Specifically, in VVC, GPM is used for inter prediction block. In an example, the GPM is only applied to CUs that are 8×8 or larger. The GPM can be signaled using a CU-level flag as one kind of merge modes, with other merge modes, such as a regular merge mode, a merge with motion vector difference (MMVD) mode, a combined inter and intra prediction (CIIP) mode and a subblock merge mode.

When the GPM mode is used on a CU, the CU is split by a partition edge into two geometric-shaped partitions using one of a plurality of partitioning manners. In some examples, 64 different partitioning manners are used. The partitioning manners can be differentiated by 24 angles (non-uniformed quantized between 0 and 360°) and up to 4 edges relative to the center of the CU for each angle. The partition edge is a line that intersects boundaries of the CU and splits the CU into two partitions.

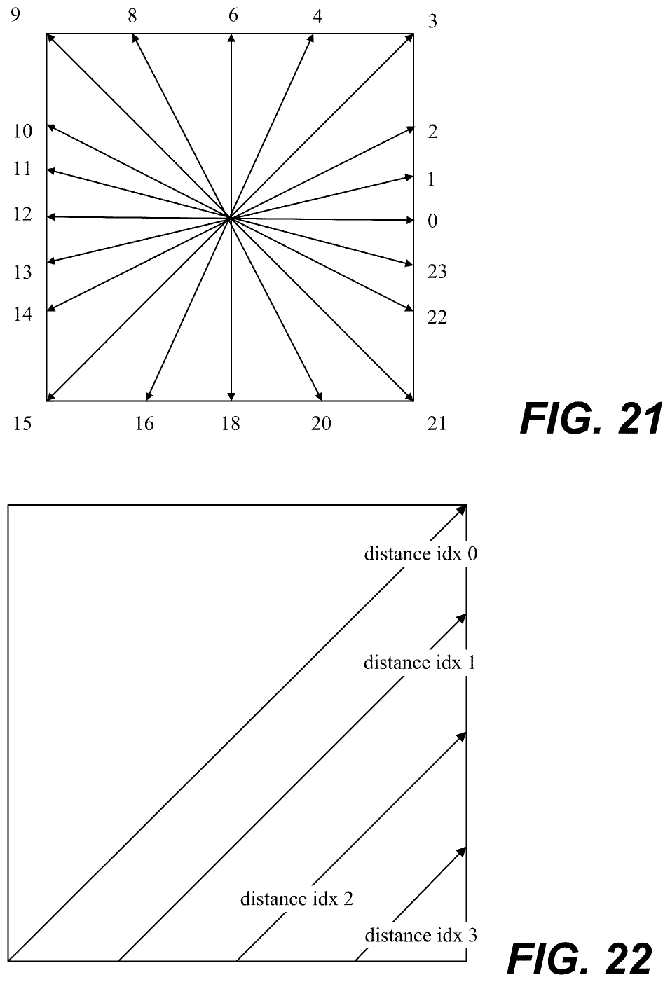

FIG. 21 shows a diagram of 24 angles that are used in the GPM in some examples. The angles can be identified using angle indices, such as angle index 0 to angle index 23 in some examples.

FIG. 22 shows a diagram of possible partition edges for the angle index 3 in an example. In FIG. 22, four possible partition edges can be associated with the angle index 3. It is noted that, for some angle indices, three possible partition edges may be associated with each angle index.

In some examples, each geometric partition in the CU is inter-predicted using its own motion. In an example, only uni-prediction is allowed for each partition, that is, each partition has one motion vector and one reference picture index. The uni-prediction motion constraint is applied to ensure that, similar to bi-prediction, two motion compensated predictions are used for each CU.

In some examples, when the GPM is used for the current CU, then a signal indicating the geometric partition index (e.g., indicating an angle and an edge), and two merge indices (one for each partition) are further signalled. In an example, the number of maximum GPM candidate size is signalled explicitly at slice level and specifies syntax binarization for GPM merge indices.

It is also noted that, in some examples, the two partitions of an inter coded block can be respectively coded by inter prediction and intra prediction. The information of the intra prediction can be regarded as the intra prediction information associated with the inter coded block.

It is also noted that in some codecs, a buffer is used to store intra prediction information of CUs. For each CU, no matter the CU is inter coded or intra coded, intra prediction information is derived and stored in the buffer. The intra prediction information in the buffer can be used for transform kernel derivation in some examples. The transform kernel derivation can be used for primary transform and/or secondary transform.

In some codec examples (e.g., VVC), multiple transform types, such as type-2 DCT (DCT-2), type-7 DST (DST-7), type-8 DCT (DCT-8), and the like can be used in the primary transform. In some examples, techniques that are referred to as multiple transform selection (MTS) can be used. In an example, an explicit MTS can use a signal to explicitly indicate a selection of a transform kernel. In another example, an implicit MTS can implicitly derive a selection of a transform kernel. In some aspects, the explicit MTS can be applied to both intra and inter coded blocks, while the implicit MTS can be used only for intra coded blocks. In an aspect, in the explicit MTS, the choice of DST-7/DCT-8 is indicated by explicit signaling of the transform type. In another aspect, in implicit MTS, the transform type is selected based on coded information that is known to both the encoder and decoder, and transform type signaling is not needed.

In some examples, in the explicit MTS, the index (e.g., denoted by mts_idx) is signaled at the end of CU level syntax to indicate the transform type for horizontal transform and vertical transform. In an example, the value of mts_idx ranges from 0 to 4. For example, value 0 of mts_idx indicates a use of DCT-2 for horizontal transform and vertical transform; value 1 of mts_idx indicates a use of DST-7 for horizontal transform and vertical transform; value 2 of mts_idx indicates a use of DCT-8 for horizontal transform and DST-7 for vertical transform; value 3 of mts_idx indicates a use of DST-7 for horizontal transform and DCT-8 for vertical transform; and value 4 of mts_idx indicates a use of DCT-8 for horizontal transform and vertical transform.

In some examples, secondary transform can be applied following the primary transform. For example, low-frequency non-separable transform (LFNST) is a non-separable transform that can be applied to the top-left low-frequency region of primary transform coefficients. In some examples (e.g., VVC), the LFNST can be applied for intra coded blocks that use DCT-2 as the primary transform. The transform kernels defined in LFNST can include multiple transform sets, such as 4 transform sets in VVC. In some examples, a selection of a transform set from the four LFNST sets (e.g., denoted by lfnstSetIdx), depends on the intra prediction mode (e.g., denoted by intraPredMode).

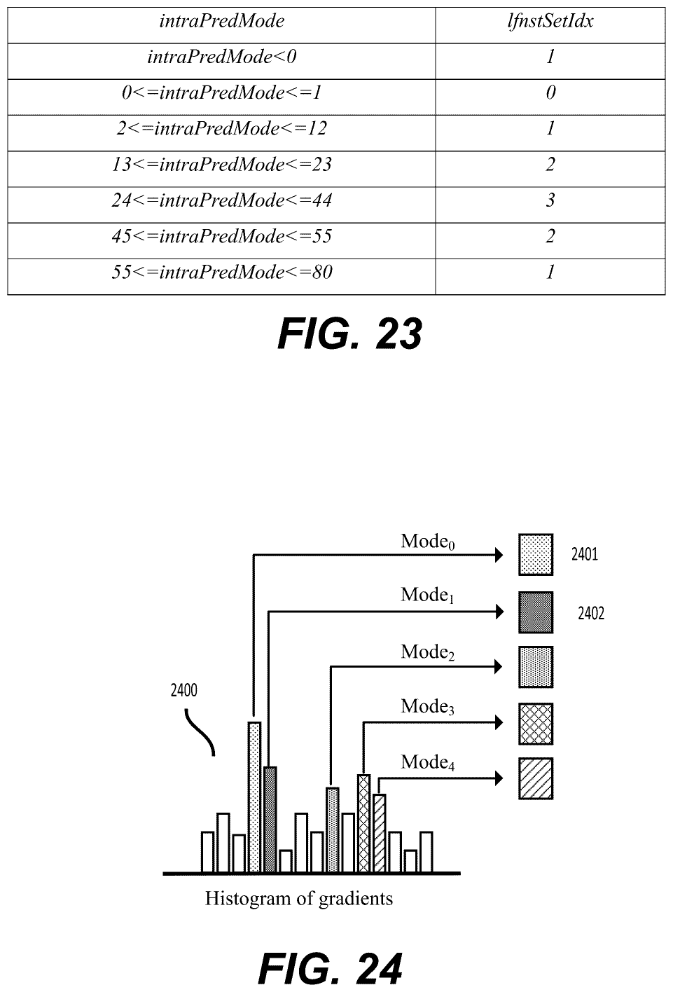

FIG. 23 shows an example of a table that maps LFNST sets to intra prediction modes.

According to some aspects of the disclosure, a primary or non-primary transform kernel (set) of a coding block can be derived based on an intra mode of the coding block, the coding block is partitioned with non-rectangular and/or rectangular boundary into two partitions, one of the two partitions is predicted with inter prediction and the other of the two partitions is predicted with intra prediction (e.g., based on the intra mode). The intra mode can be adaptively selected among several candidates. In some examples, the coding block is still considered as an inter coded block.

In some aspects, the intra mode candidates (candidates for the intra mode) include a first intra mode (also referred to as mode A) that is associated with the partition direction of the coding block. In some examples, the first intra mode is derived based on a pre-define look-up table with partition direction as the input. The pre-defined look-up table associates partition directions respectively with intra modes.

In some aspects, the intra mode candidates include a second intra mode that is also referred to as a virtual intra mode or mode B). The virtual intra mode is derived by a decoder side mode derivation method, such as decoder side intra mode derivation (DIMD). For example, in the decoder side mode derivation method, a histogram of gradients for all predicted samples of the current block is built. The directions indicated by the histogram of gradients are then mapped to directional intra modes, and the directional intra modes can be ranked.

FIG. 24 shows a diagram of a histogram of gradients for predicted samples of the current block in an example. The predicted samples of the current block can be inter predicted or intra predicted. In an example, the most frequent mode is derived as the virtual intra mode, as shown mode (2401) in FIG. 24. In another example, the 2^{nd} most frequent mode is derived as the virtual intra mode, such as mode (2402) in FIG. 24.

In some aspects, the mode A and the mode B can be adaptively selected (e.g., as the intra mode to derive the primary transform kernel or the non-primary transform kernel) based on the similarity between the mode A and the mode B. For example, when the difference between A and B is smaller than a given threshold, the mode A is used. Otherwise, mode B is used.

In some aspects, the inter predicted partition in the two partitions of the coding block can include a partition that is generated by block-vector-based prediction, such as intra block copy with explicitly signaling block vector, or intra template matching mode with implicitly deriving block vector by template matching. The block vectors can be used as the motion vector role in inter prediction.

In some aspects, the activation of a technique of using an intra mode for transform kernel derivation of an inter coded block is explicitly signaled with a syntax, such as a flag. For example, when the flag is 1, the technique of using an intra mode for transform kernel derivation of inter coded blocks is activated; and when the flag is 0, the technique of using an intra mode for transform kernel derivation of inter coded blocks is disabled.

In some aspects, the activation of a technique of using an intra mode for transform kernel derivation of an inter coded block is implicitly determined based on the already coded information, such as template of this current block, boundary information of neighboring codec blocks, frequency of intra mode in neighboring pre-defined area, and the like.

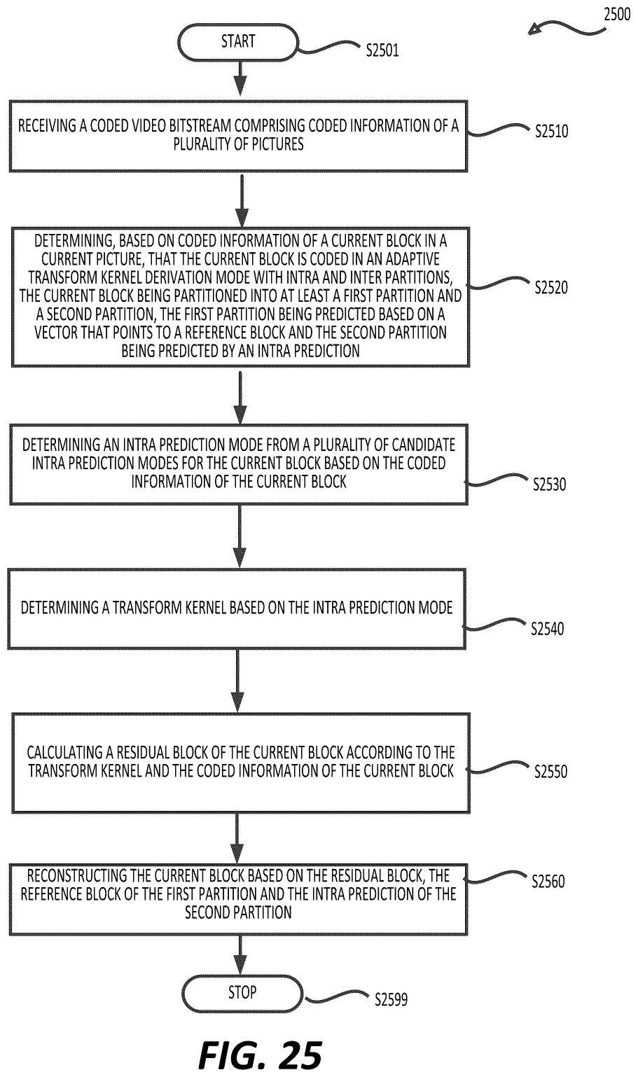

FIG. 25 shows a flow chart outlining a process (2500) according to an aspect of the disclosure. The process (2500) can be used in a video decoder. In various aspects, the process (2500) is executed by processing circuitry, such as the processing circuitry that performs functions of the video decoder (110), the processing circuitry that performs functions of the video decoder (210), and the like. In some aspects, the process (2500) is implemented in software instructions, thus when the processing circuitry executes the software instructions, the processing circuitry performs the process (2500). The process starts at (S2501) and proceeds to (S2510).

At (S2510), a coded video bitstream is received. The coded video bitstream includes coded information of a plurality of pictures.

At (S2520), based on coded information of a current block in a current picture, it is determined that the current block is coded in an adaptive transform kernel derivation mode with intra and inter partitions, the current block is partitioned into at least a first partition and a second partition, the first partition is predicted based on a vector that points to a reference block and the second partition is predicted by an intra prediction.

At (S2530), an intra prediction mode is determined from a plurality of candidate intra prediction modes for the current block based on the coded information of the current block.

At (S2540), a transform kernel (set) is determined based on the intra prediction mode.

At (S2550), a residual block of the current block is calculated according to the transform kernel (set) and the coded information of the current block.

At (S2560), the current block is reconstructed based on the residual block, the reference block of the first partition and the intra prediction of the second partition.

In some examples, the current block is partitioned with a non-rectangular boundary. In some examples, the current block is partitioned with a rectangular boundary.

In some aspects, the plurality of candidate intra prediction modes include a first candidate intra prediction mode associated with a partition direction of the current block.

In some examples, the first candidate intra prediction mode is determined according to a predefined lookup table that maps partition directions to intra prediction modes.

In some aspects, the plurality of candidate intra prediction modes include a second candidate intra prediction mode that is derived based on a histogram of gradients associated with the current block.

In some examples, the histogram of gradients is built according to predicted samples of the current block, the gradients are mapped to intra prediction modes. The intra prediction modes are ranked based on the histogram of gradients; and the second candidate intra prediction mode is determined according to the intra prediction modes that are ranked based on the histogram of gradients. In an example, the second candidate intra prediction mode is a most frequent mode based on the histogram of gradients. In another example, the second candidate intra prediction mode is a second most frequent mode.

In some aspects, the plurality of candidate intra prediction modes include a first candidate intra prediction mode associated with a partition direction of the current block and a second candidate intra prediction mode that is derived based on a histogram of gradients associated with the current block. The intra prediction mode is selected from the first candidate intra prediction mode and the second candidate intra prediction mode based on a similarity between the first candidate intra prediction mode and the second candidate intra prediction mode. In an example, the first candidate intra prediction mode is selected as the intra prediction mode when a difference between the first candidate intra prediction mode and the second candidate intra prediction mode is smaller than a threshold; and the second candidate intra prediction mode is selected as the intra prediction mode when the difference is equal to or larger than the threshold.

In some aspects, the first partition is predicted based on at least one of: a motion vector based inter prediction; and a block vector based intra block copy.

In some examples, the first partition is predicted according to a block vector that is signaled in the coded video bitstream.

In some examples, the first partition is predicted according to a block vector that is derived according to a template matching.

In some examples, a syntax element is decoded, and the syntax element indicates an activation of the adaptive transform kernel derivation mode with intra and inter partitions.

In some examples, whether the adaptive transform kernel derivation mode with intra and inter partitions is activated is determined based on coded information of the current block and coded information of blocks that are decoded before the current block.

Then, the process proceeds to (S2599) and terminates.

The process (2500) can be suitably adapted. Step(s) in the process (2500) can be modified and/or omitted. Additional step(s) can be added. Any suitable order of implementation can be used.

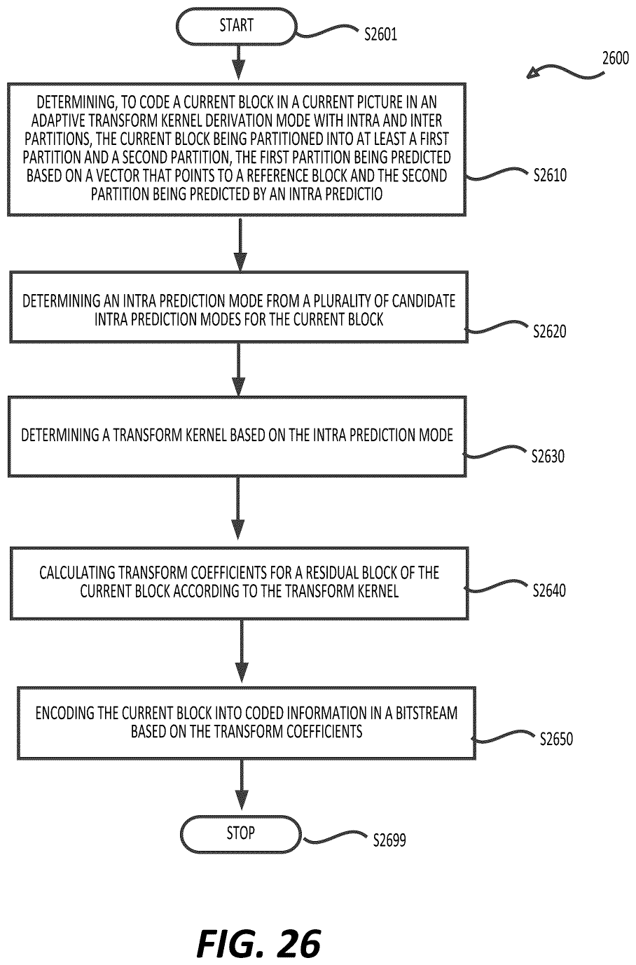

FIG. 26 shows a flow chart outlining a process (2600) according to an aspect of the disclosure. The process (2600) can be used in a video encoder. In various aspects, the process (2600) is executed by processing circuitry, such as the processing circuitry that performs functions of the video encoder (103), the processing circuitry that performs functions of the video encoder (303), and the like. In some aspects, the process (2600) is implemented in software instructions, thus when the processing circuitry executes the software instructions, the processing circuitry performs the process (2600). The process starts at (S2601) and proceeds to (S2610).

At (S2610), to code a current block in a current picture in an adaptive transform kernel derivation mode with intra and inter partitions is determined. The current block is partitioned into at least a first partition and a second partition, the first partition is predicted based on a vector that points to a reference block and the second partition is predicted by an intra prediction.

At (S2620), an intra prediction mode is determined from a plurality of candidate intra prediction modes for the current block.

At (S2630), a transform kernel (set) is determined based on the intra prediction mode.

At (S2640), transform coefficients are calculated for a residual block of the current block according to the transform kernel (set).

At (S2650), the current block is encoded into coded information in a bitstream based on the transform coefficients.

In some examples, the current block is partitioned with a non-rectangular boundary.

In some examples, the current block is partitioned with a rectangular boundary.

In some aspects, the plurality of candidate intra prediction modes include a first candidate intra prediction mode associated with a partition direction of the current block.

In some examples, the first candidate intra prediction mode is determined according to a predefined lookup table that maps partition directions to intra prediction modes.

In some aspects, the plurality of candidate intra prediction modes include a second candidate intra prediction mode that is derived based on a histogram of gradients associated with the current block.

In some examples, the histogram of gradients is built according to predicted samples of the current block, the gradients are mapped to intra prediction modes. The intra prediction modes based on the histogram of gradients. The second candidate intra prediction mode is determined according to the intra prediction modes that are ranked based on the histogram of gradients. In an example, the second candidate intra prediction mode is a most frequent mode based on the histogram of gradients. In anther example, the second candidate intra prediction mode is a second most frequent mode.

In some aspects, the plurality of candidate intra prediction modes include a first candidate intra prediction mode associated with a partition direction of the current block and a second candidate intra prediction mode that is derived based on a histogram of gradients associated with the current block. The intra prediction mode is selected from the first candidate intra prediction mode and the second candidate intra prediction mode based on a similarity between the first candidate intra prediction mode and the second candidate intra prediction mode. In an example, the first candidate intra prediction mode is selected as the intra prediction mode when a difference between the first candidate intra prediction mode and the second candidate intra prediction mode is smaller than a threshold. In another example, the second candidate intra prediction mode is selected as the intra prediction mode when the difference is equal to or larger than the threshold.

In some aspects, the first partition is predicted based on at least one of: a motion vector based inter prediction; and a block vector based intra block copy.

In some examples, the first partition is predicted according to a block vector, and the block vector is encoded in the bitstream.

In some examples, the first partition is predicted according to a block vector, the block vector is derived according to a template matching.

In some aspects, a syntax element is encoded into the bitstream, the syntax element indicates an activation of the adaptive transform kernel derivation mode with intra and inter partitions.

Then, the process proceeds to (S2699) and terminates.

The process (2600) can be suitably adapted. Step(s) in the process (2600) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that, based on coded information of a current block in a current picture, the current block is determined in an adaptive transform kernel derivation mode with intra and inter partitions, the current block is partitioned into at least a first partition and a second partition, the first partition is predicted based on a vector that points to a reference block and the second partition is predicted by an intra prediction. The format rule also specifies that an intra prediction mode is selected from a plurality of candidate intra prediction modes for the current block based on the coded information of the current block; a transform kernel (set) is determined based on the intra prediction mode; a residual block of the current block is calculated according to the transform kernel (set) and the coded information of the current block; and the current block is reconstructed based on the residual block, the reference block of the first partition and the intra prediction of the second partition.

Some aspects of the disclosure also provide techniques for transform kernel derivation for cross-component predicted chroma blocks.

In some examples, the primary (or secondary) transform kernel sets are trained to compact different residual information adaptively. The transform kernel set (used for encoding/decoding) a block can be determined based on intra prediction mode.

In some examples, for cross-component predicted chroma blocks, when no conventional intra mode is applied (in the chroma blocks), the intra mode information to determine transform kernel set (for the chroma blocks) can be inherited from corresponding luma block's intra mode information. The transform kernel set for cross-component predicted chroma block is then determined based on the inherited intra mode information.

According to an aspect, the mapping between intra modes and transform kernels might not always be optimal, inheriting intra mode and then mapping the intra mode to the transform kernel for the chroma blocks might result in sub-optimal coding performance.

Some aspects of the disclosure provide techniques to derive a primary or non-primary transform kernel for cross-component predicted chroma blocks based on the corresponding luma block's transform (kernel) set information (e.g., including a plurality of transform kernel sets) directly, instead of inheriting the intra mode information of the luma block. The techniques are used when a chroma block is in a cross-component transform kernel sets mode.

In some aspects, the mapping between the intra modes and transform kernel sets is defined using a lookup table (LUT), the transform kernel set is denoted by TXS and intra prediction mode is denoted by IPM, then using the lookup table to determine a transform kernel set corresponding to an intra prediction mode can be represented using Eq. (1):

$$TXS = LUT [ IPM ] \qquad Eq . ( 1 )$$

In some examples, the inheritance of transform kernel information of the luma block can be performed by inheriting a new IPM′ of the luma block, such as represented using Eq. (2)

$$TXS = LUT [ {IPM}^{′} ] \qquad Eq . ( 2 )$$

In some examples, the IPM stored in intra mode buffer of the luma and the new IPM′ of the luma block are derived from a decoder side mode derivation method. For example, according to the decoder side mode derivation method, a histogram of gradients for all predicted samples of the current block or reconstructed samples in template area is built. Gradient directions indicated by the histogram of gradients are then respectively mapped to directional intra modes and the directional intra modes can be ranked.

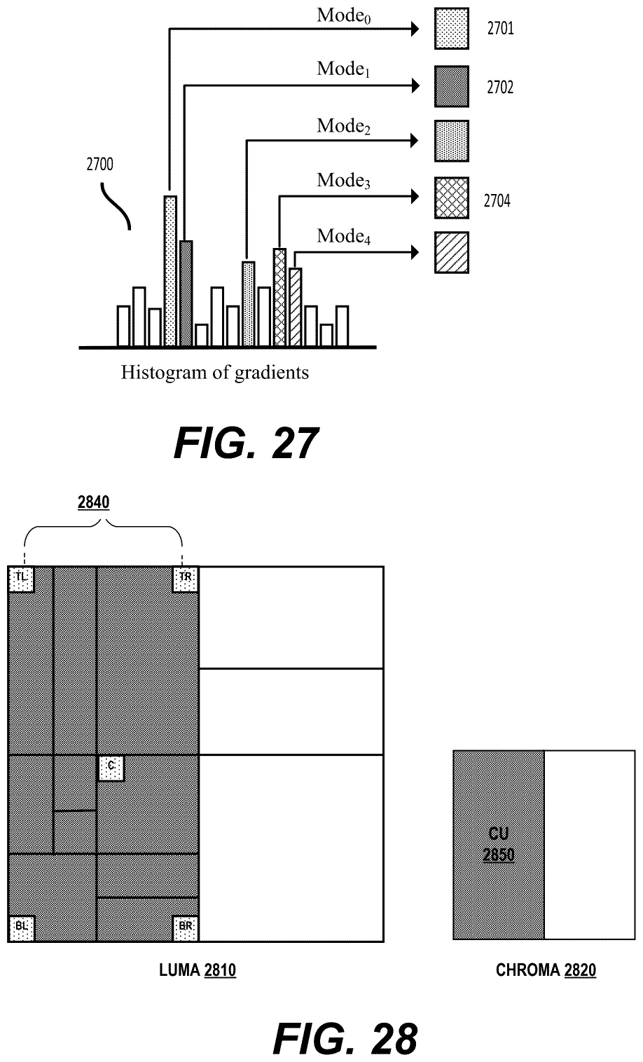

FIG. 27 shows a diagram of a histogram of gradients (2700) in some examples. The histogram of gradients (2700) is constructed according to all predicted samples of the current block and/or reconstructed samples in a template area of the current block.

In an example, IPM is derived to correspond to the most frequent mode, such as Mode₀ shown by (2701) in FIG. 27.

In another example, IPM′ is derived to correspond to the 2nd most frequent mode, such as Mode₁ shown by (2702) in FIG. 27.

In another example, IPM′ is derived to correspond to the 3rd most frequent mode as such as Mode₃ shown by (2704) in FIG. 27.

In another example, the corresponding luma block is intra predicted block and the intra prediction type is non-conventional intra prediction, such as decoder side intra mode derivation, template-based intra mode derivation, occurrence-based intra coding, extrapolation-filter-based intra prediction, spatial geometric partitioning mode, intra template match mode, matrix-based multiplication mode, and the like.

In another example, the corresponding luma block is inter predicted block.

In some aspects, the activation of the cross-component transform kernel sets mode is explicitly signaled with a syntax. For example, the inheritance of luma transform kernel set information is one of the possible transform kernel set derivation methods for cross-component predicted chroma block. The syntax can be set to indicate the cross-component transform kernel sets mode is activated.

In some aspects, when the corresponding luma area has different partition scheme from the chroma block, the inheritance occurs to pre-defined positions in the luma area. In an example, one of the pre-defined positions can be chosen.

FIG. 28 shows a diagram different partition schemes for luma and chroma in some examples. In the FIG. 28 example, luma component of a coding unit is partition as shown by (2810), and a corresponding chroma component of the coding unit is partitioned as shown by (2820). In an example, a current block (2850) which is a chroma block can inherit transform kernel set information directly from pre-defined positions for inheritance. For example, the current block (2850) is chroma component corresponding to a portion (2840) of luma component in FIG. 28. In an example, the current block (2850) can inherit transform kernel information from a center position (shown by C in FIG. 28) of the portion (2840). In another example, the current block (2850) can inherit transform kernel information from a top-left position (shown by TL in FIG. 28) of the portion (2840). In another example, the current block (2850) can inherit transform kernel information from a top-right position (shown by TR in FIG. 28) of the portion (2840). In an example, the current block (2850) can inherit transform kernel information from a bottom left position (shown by BL in FIG. 28) of the portion (2840). In an example, the current block (2850) can inherit transform kernel information from a bottom right position (shown by BR in FIG. 28) of the portion (2840).

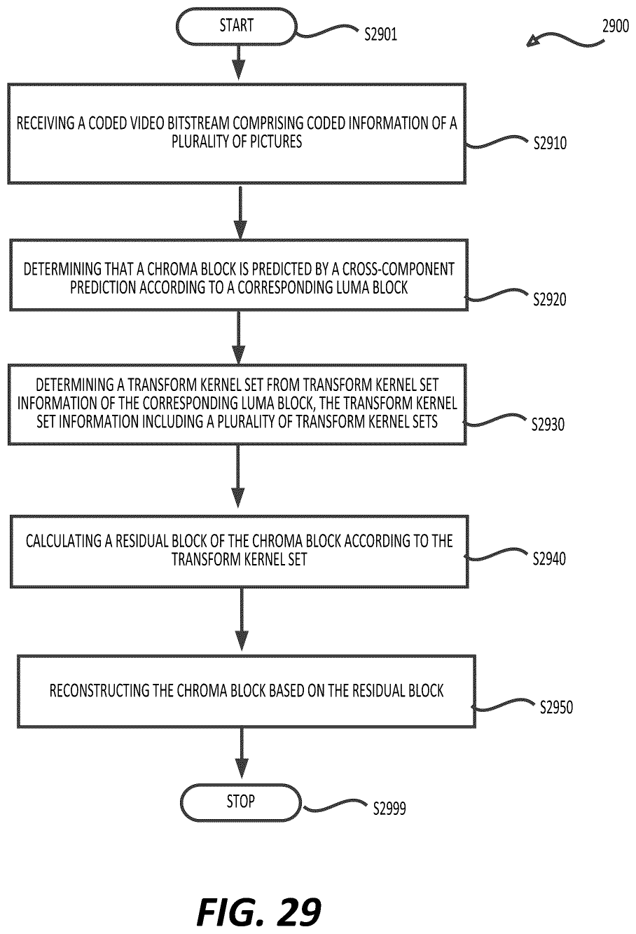

FIG. 29 shows a flow chart outlining a process (2900) according to an aspect of the disclosure. The process (2900) can be used in a video decoder. In various aspects, the process (2900) is executed by processing circuitry, such as the processing circuitry that performs functions of the video decoder (110), the processing circuitry that performs functions of the video decoder (210), and the like. In some aspects, the process (2900) is implemented in software instructions, thus when the processing circuitry executes the software instructions, the processing circuitry performs the process (2900). The process starts at (S2901) and proceeds to (S2910).

At (S2910), a coded video bitstream is received. The coded video bitstream includes coded information of a plurality of pictures.

At (S2920), it is determined that a chroma block is predicted by a cross-component prediction according to a corresponding luma block.

At (S2930), a transform kernel set is determined from transform kernel set information of the corresponding luma block, the transform kernel set information indicates a plurality of transform kernel sets.

At (S2940), a residual block of the chroma block is calculated according to the transform kernel set.

At (S2950), the chroma block is reconstructed based on the residual block.

Then, the process proceeds to (S2999) and terminates.

The process (2900) can be suitably adapted. Step(s) in the process (2900) can be modified and/or omitted. Additional step(s) can be added. Any suitable order of implementation can be used.

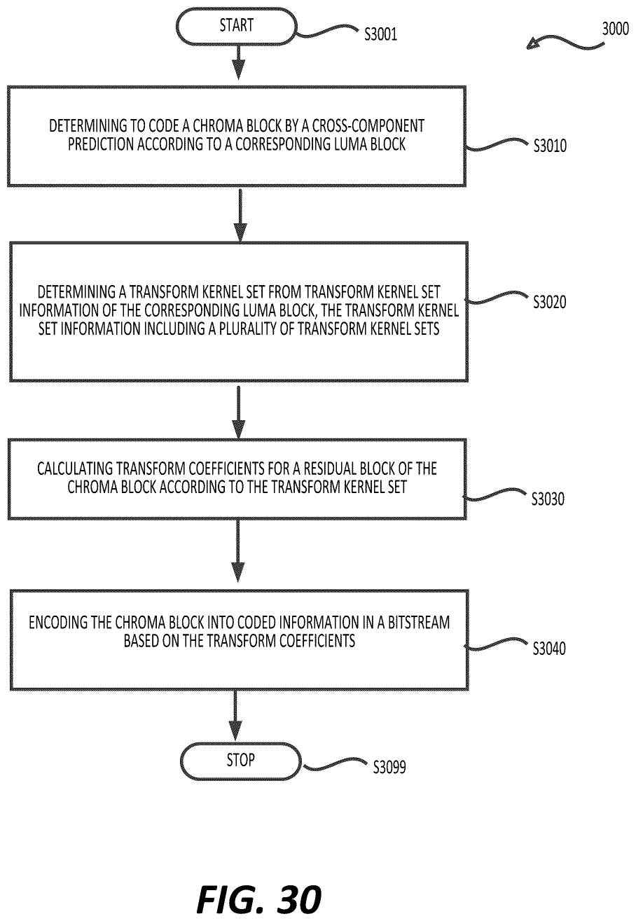

FIG. 30 shows a flow chart outlining a process (3000) according to an aspect of the disclosure. The process (3000) can be used in a video encoder. In various aspects, the process (3000) is executed by processing circuitry, such as the processing circuitry that performs functions of the video encoder (103), the processing circuitry that performs functions of the video encoder (303), and the like. In some aspects, the process (3000) is implemented in software instructions, thus when the processing circuitry executes the software instructions, the processing circuitry performs the process (3000). The process starts at (S3001) and proceeds to (S3010).

At (S3010), to code a chroma block by a cross-component prediction according to a corresponding luma block is determined.

At (S3020), a transform kernel set is determined from transform kernel set information of the corresponding luma block, the transform kernel set information indicates a plurality of transform kernel sets.

At (S3030), transform coefficients for a residual block of the chroma block are calculated according to the transform kernel set.

At (S3040), the chroma block is encoded into coded information in a bitstream based on the transform coefficients.

Then, the process proceeds to (S3099) and terminates.

The process (3000) can be suitably adapted. Step(s) in the process (3000) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that a chroma block is determined to be predicted by a cross-component prediction according to a corresponding luma block; and a transform kernel set is determined from transform kernel set information of the corresponding luma block, the transform kernel set information indicates a plurality of transform kernel sets. The format rule also specifies that a residual block of the chroma block is calculated according to the transform kernel set; and the chroma block is reconstructed based on the residual block.

Some aspects of the disclosure provide techniques for transform kernel derivation with adaptive decoder-side intra mode derivation. The techniques can improve selective transform kernel set based on intra prediction mode.

Some techniques of decoder-side intra mode derivation are described with FIG. 6.

In a variance of the techniques of decoder-side intra mode derivation, the input samples are changed from the reconstructed samples in template area to the prediction samples of the current block.

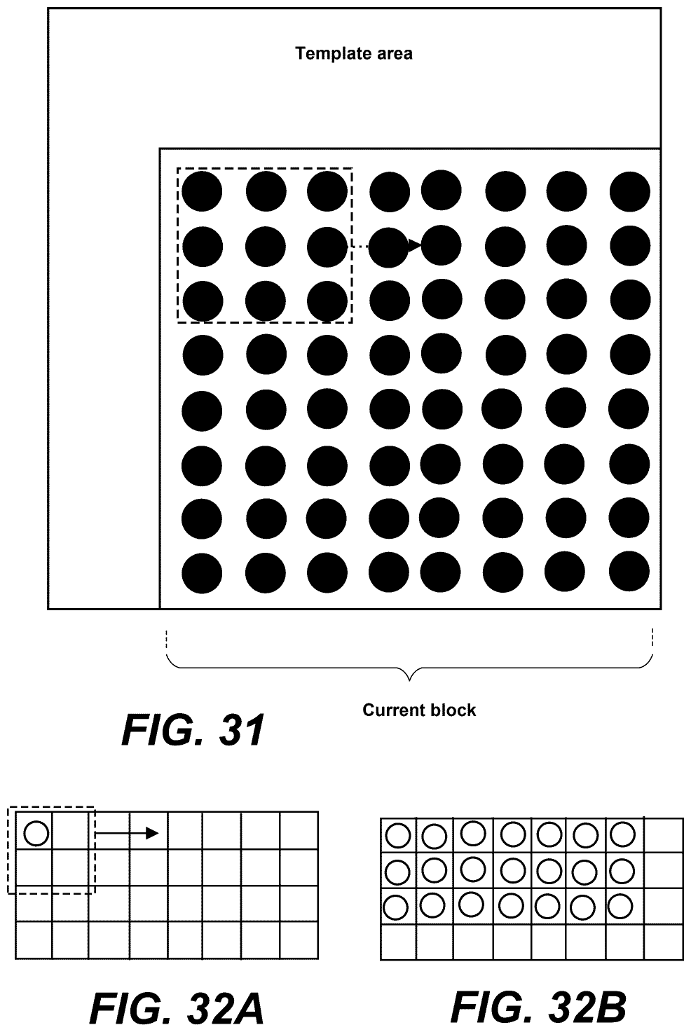

FIG. 31 shows a diagram of a current block with a template area in some examples. The current block in FIG. 31 is an 8×8 block. In an example, the middle 6×6 samples are used to build a histogram of gradients because the 3×3 Sobel filter requires one additional line to ensure all samples are from current block.

In some examples, using a fixed number of samples with a fixed Sobel filter to build the histogram of gradients may give an inaccurate intra mode derivation. Furthermore, when the primary (or secondary) transform kernel is determined based on the intra prediction mode information, inaccurate intra mode derivation might result in sub-optimal transform kernel selection.

In the following description, method A refers to the techniques of decoder-side intra mode derivation.

Some aspects of the disclosure provide a set of variances of method A to determine the transform kernel set. The selection of a variance of method A is based on already coded information or signaled by a syntax.

In some aspects, for small blocks with size smaller than a given threshold (M×N), the 3×3 Sobel filter are replaced by a 2×2 filer to increase the number of samples to build the histogram. For example, the position of samples considered in this 2×2 windows corresponds to the top-left one (position in the 2×2 windows). Accordingly, the samples considered for histogram have width of (W−1) and height of (H−1), W and H are the original width and height of the current block.

FIGS. 32A-32B show diagrams of a current block for decoder-side intra mode derivation in some example. FIG. 32A shows a use of 2×2 filter to derive a (gradient) sample at a top-left position shown by a circle. FIG. 32b shows positions (shown by circles) of gradient samples of the current block.

In an example, the threshold size M and N are both set to 8.

In another example, the threshold size is given as the number of samples S (e.g. S=64) without specifying the block shape.

In some aspects, for large blocks with size equal to or larger than a given threshold size (M×N), the samples used to build the histogram of gradients are scanned in a pre-defined order. A threshold value is given while building the histogram of gradients. When a condition based on the threshold value is met, the building of histogram in method A is terminated. The early termination of the building of histogram can help to filter out inaccurate samples within big blocks.

In an example, the scan order is a zig-zag scan order, with samples in the top-left area of the current block being scanned first.

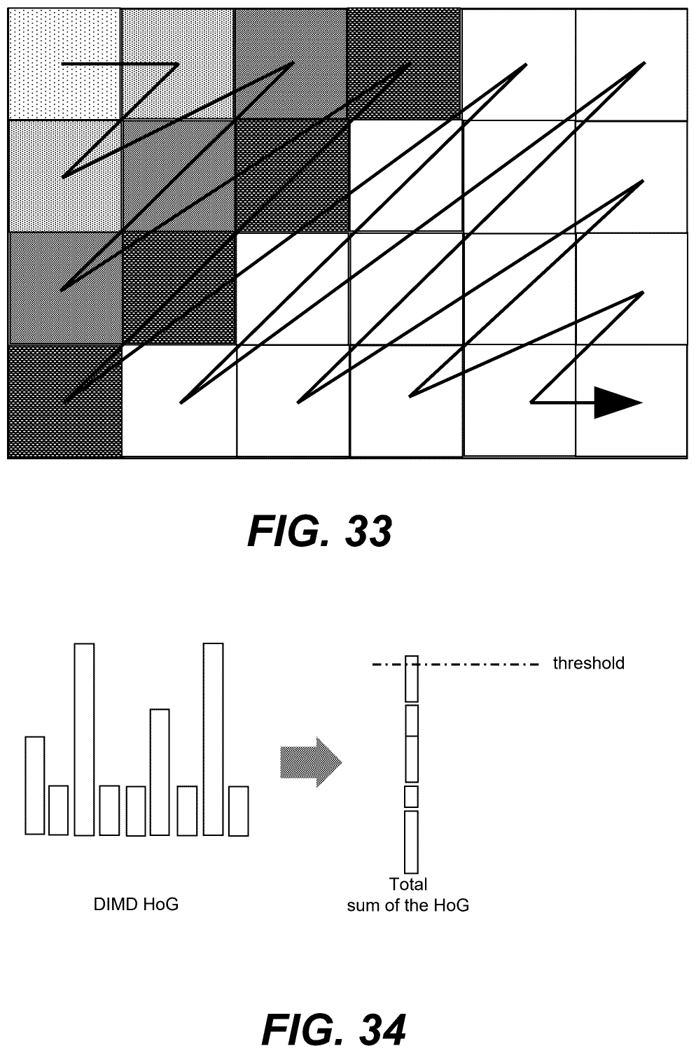

FIG. 33 shows a diagram of a zig-zag scan order in a current block for building a histogram of gradients in some examples.

In an example, the threshold value used to terminate the building histogram is determined based on block size information. The condition to terminate the building histogram is defined to be when the accumulated histogram of gradients is larger than and/or equal to the given threshold.

FIG. 34 shows a diagram of early termination condition of histogram building based on a threshold value in some examples. During the process of histogram building, a total number of gradient samples for different gradients can be summed. When the total sum (number) of gradient samples in the histogram of gradients is larger than a threshold, the process of histogram building can be terminated. The threshold can be determined based on block size.

In an example, the threshold size M and N are set to 8 and 16, respectively.

In another example, the threshold size is given as the number of samples S (e.g. S=128) without specifying the block shape.

In some aspects, a portion of the samples can be excluded for HoG building. For example, top-left samples in an L shape template of the current block are not accounted from HoG building.

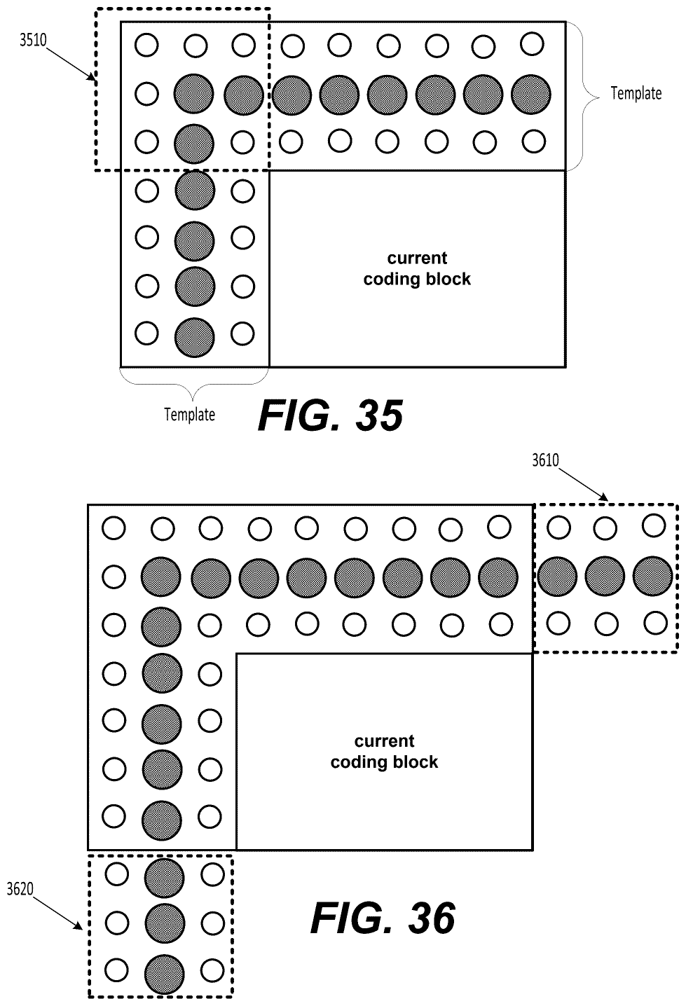

FIG. 35 shows a diagram of a current block with an L-shaped template in some examples. Top-left samples, such as shown by samples in a box (3510) in FIG. 35, are excluded from HoG building.

In some aspects, extended portions of the template can be accounted in the HoG building.

FIG. 36 shows a diagram of a current block with an L-shaped template in some examples. A top-right portion of samples (such as shown by samples in a box (3610) in FIG. 36) to the L-shaped template and/or a bottom-left portion of samples (such as shown by samples in a box (3620) in FIG. 36) to the L-shaped template can be accounted into HoG building.

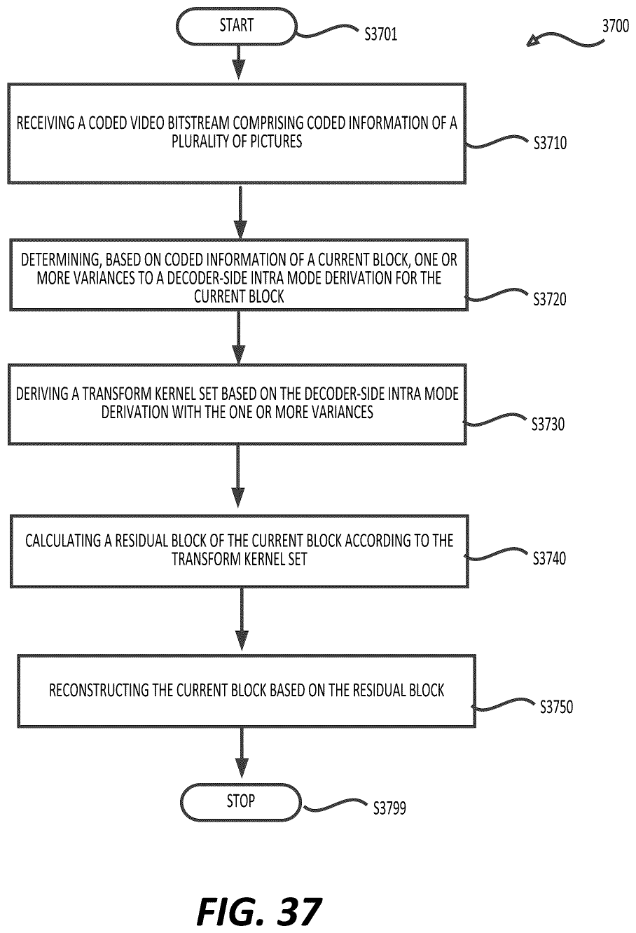

FIG. 37 shows a flow chart outlining a process (3700) according to an aspect of the disclosure. The process (3700) can be used in a video decoder. In various aspects, the process (3700) is executed by processing circuitry, such as the processing circuitry that performs functions of the video decoder (110), the processing circuitry that performs functions of the video decoder (210), and the like. In some aspects, the process (3700) is implemented in software instructions, thus when the processing circuitry executes the software instructions, the processing circuitry performs the process (3700). The process starts at (S3701) and proceeds to (S3710).

At (S3710), a coded video bitstream is received. The coded video bitstream includes coded information of a plurality of pictures.

At (S3720), based on coded information of a current block, one or more variances to a decoder-side intra mode derivation for the current block are determined.

At (S3730), a transform kernel set is derived based on the decoder-side intra mode derivation with the one or more variances.

At (S3740), a residual block of the current block is calculated according to the transform kernel set.

At (S3750), the current block is reconstructed based on the residual block.

Then, the process proceeds to (S3799) and terminates.

The process (3700) can be suitably adapted. Step(s) in the process (3700) can be modified and/or omitted. Additional step(s) can be added. Any suitable order of implementation can be used.

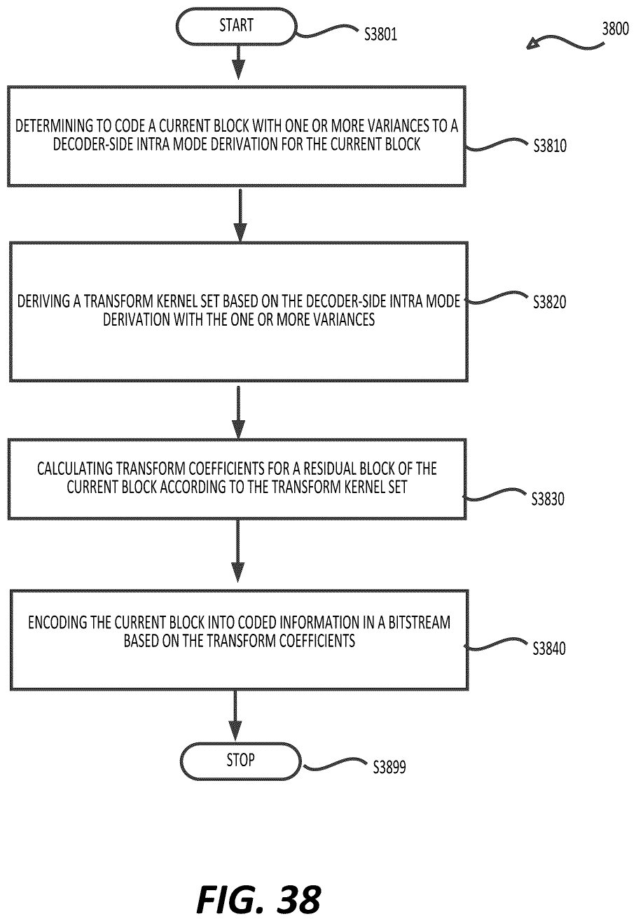

FIG. 38 shows a flow chart outlining a process (3800) according to an aspect of the disclosure. The process (3800) can be used in a video encoder. In various aspects, the process (3800) is executed by processing circuitry, such as the processing circuitry that performs functions of the video encoder (103), the processing circuitry that performs functions of the video encoder (303), and the like. In some aspects, the process (3800) is implemented in software instructions, thus when the processing circuitry executes the software instructions, the processing circuitry performs the process (3800). The process starts at (S3801) and proceeds to (S3810).

At (S3810), to code a current block with one or more variances to a decoder-side intra mode derivation for the current block is determined.

At (S3820), a transform kernel set is derived based on the decoder-side intra mode derivation with the one or more variances.

At (S3830), transform coefficients are calculated for a residual block of the current block according to the transform kernel set.

At (S3840), the current block is encoded into coded information in a bitstream based on the transform coefficients.

Then, the process proceeds to (S3899) and terminates.

The process (3800) can be suitably adapted. Step(s) in the process (3800) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that based on coded information of a current block, one or more variances to a decoder-side intra mode derivation for the current block are determined; a transform kernel set is derived based on the decoder-side intra mode derivation with the one or more variances; a residual block of the current block is calculated according to the transform kernel set; and the current block is reconstructed based on the residual block.

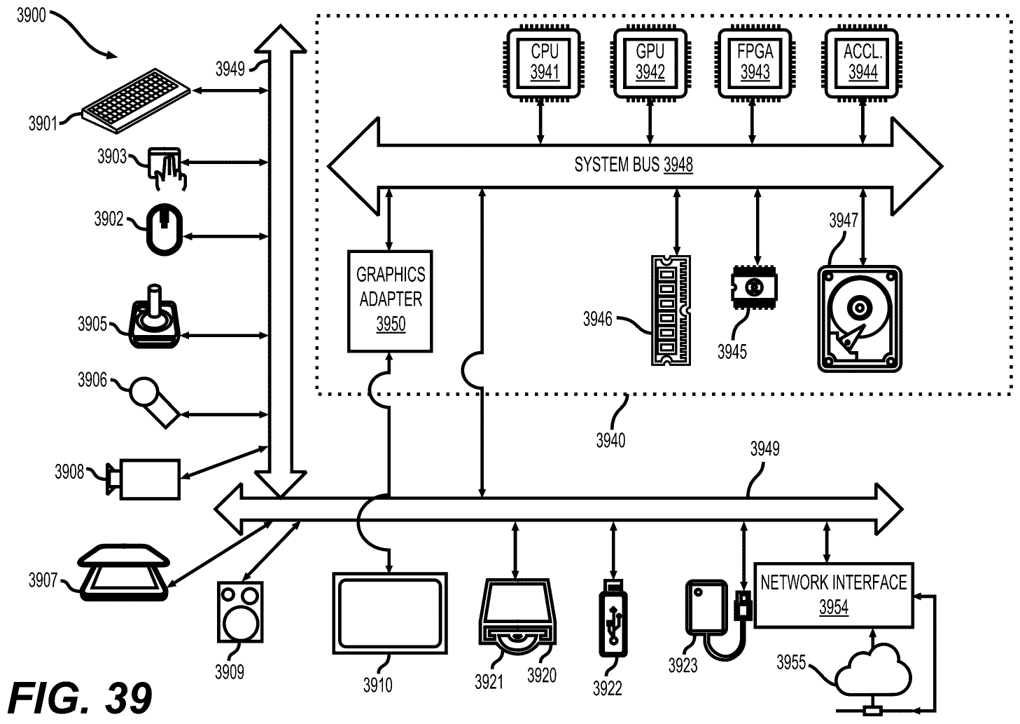

The techniques described above, can be implemented as computer software using computer-readable instructions and physically stored in one or more computer-readable media. For example, FIG. 39 shows a computer system (3900) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 39 for computer system (3900) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (3900).

Computer system (3900) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (3901), mouse (3902), trackpad (3903), touch screen (3910), data-glove (not shown), joystick (3905), microphone (3906), scanner (3907), camera (3908).

Computer system (3900) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (3910), data-glove (not shown), or joystick (3905), but there can also be tactile feedback devices that do not serve as input devices), audio output devices (such as: speakers (3909), headphones (not depicted)), visual output devices (such as screens (3910) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (3900) can also include human accessible storage devices and their associated media such as optical media including CD/DVD ROM/RW (3920) with CD/DVD or the like media (3921), thumb-drive (3922), removable hard drive or solid state drive (3923), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (3900) can also include an interface (3954) to one or more communication networks (3955). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (3949) (such as, for example USB ports of the computer system (3900)); others are commonly integrated into the core of the computer system (3900) by attachment to a system bus as described below (for example Ethernet interface into a PC computer system or cellular network interface into a smartphone computer system). Using any of these networks, computer system (3900) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (3940) of the computer system (3900).

The core (3940) can include one or more Central Processing Units (CPU) (3941), Graphics Processing Units (GPU) (3942), specialized programmable processing units in the form of Field Programmable Gate Areas (FPGA) (3943), hardware accelerators for certain tasks (3944), graphics adapters (3950), and so forth. These devices, along with Read-only memory (ROM) (3945), Random-access memory (3946), internal mass storage such as internal non-user accessible hard drives, SSDs, and the like (3947), may be connected through a system bus (3948). In some computer systems, the system bus (3948) can be accessible in the form of one or more physical plugs to enable extensions by additional CPUs, GPU, and the like. The peripheral devices can be attached either directly to the core's system bus (3948), or through a peripheral bus (3949). In an example, the screen (3910) can be connected to the graphics adapter (3950). Architectures for a peripheral bus include PCI, USB, and the like.

CPUs (3941), GPUs (3942), FPGAs (3943), and accelerators (3944) can execute certain instructions that, in combination, can make up the aforementioned computer code. That computer code can be stored in ROM (3945) or RAM (3946). Transitional data can also be stored in RAM (3946), whereas permanent data can be stored for example, in the internal mass storage (3947). Fast storage and retrieve to any of the memory devices can be enabled through the use of cache memory, that can be closely associated with one or more CPU (3941), GPU (3942), mass storage (3947), ROM (3945), RAM (3946), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (3900), and specifically the core (3940) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (3940) that are of non-transitory nature, such as core-internal mass storage (3947) or ROM (3945). The software implementing various aspects of the present disclosure can be stored in such devices and executed by core (3940). A computer-readable medium can include one or more memory devices or chips, according to particular needs. The software can cause the core (3940) and specifically the processors therein (including CPU, GPU, FPGA, and the like) to execute particular processes or particular parts of particular processes described herein, including defining data structures stored in RAM (3946) and modifying such data structures according to the processes defined by the software. In addition or as an alternative, the computer system can provide functionality as a result of logic hardwired or otherwise embodied in a circuit (for example: accelerator (3944)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1). A method of video decoding, including: receiving a coded video bitstream including coded information of a plurality of pictures; determining, based on coded information of a current block in a current picture, that the current block is coded using an intra prediction that generates prediction samples of the current block based on reference samples in the current picture; determining at least a first transform kernel set based on a histogram of occurrence (HoC) of intra prediction modes in neighboring samples of the current block; calculating, based on the coded information of the current block, a residual block of the current block according to at least the first transform kernel set; and reconstructing the current block based on the residual block and the intra prediction of the current block.
(2). The method of feature (1), in which the determining at least the first transform kernel set includes: determining at least a first intra prediction mode based on the HoC of the intra prediction modes in the neighboring samples of the current block; and determining the first transform kernel set that maps to the first intra prediction mode according to a one-to-one mapping of the intra prediction modes to transform kernel sets.
(3). The method of any of features (1) to (2), in which the determining at least the first intra prediction mode includes: determining the first intra prediction mode that has a highest occurrence in the intra prediction modes of the HoC.
(4). The method of any of features (1) to (3), in which the determining at least the first intra prediction mode includes: determining the first intra prediction mode that has a second highest occurrence in the intra prediction modes of the HoC.
(5). The method of any of features (1) to (4), in which the determining at least the first intra prediction mode includes: determining the first intra prediction mode that has an occurrence value higher than an occurrence threshold according to the HoC.
(6). The method of any of features (1) to (5), in which the first intra prediction mode is a planar mode that is predefined.
(7). The method of any of features (1) to (6), in which the determining at least the first intra prediction mode includes: determining a highest occurrence mode that has a highest occurrence in the intra prediction modes of the HoC; and determining the first intra prediction mode by applying an offset to the highest occurrence mode.
(8). The method of any of features (1) to (7), in which the determining at least the first transform kernel set includes: determining at least a first intra prediction mode and a second intra prediction mode based on the HoC of the intra prediction modes in the neighboring samples of the current block; and determining the first transform kernel set and a second transform kernel that respectively map to the first intra prediction mode and the second intra prediction mode according to a one-to-one mapping of the intra prediction modes to transform kernel sets.
(9). The method of any of features (1) to (8), in which the determining at least the first transform kernel set includes: constructing a most probable transform kernel candidate list that includes a plurality of transform kernel sets based on the HoC of the intra prediction modes in the neighboring samples of the current block.
(10). The method of any of features (1) to (9), further including: decoding a syntax element from the coded information of the current block, the syntax element indicating a selected transform kernel set from at least the first transform kernel set, the selected transform kernel set being used for the calculating of the residual block of the current block.
(11). The method of any of features (1) to (10), further including at least one of: using the HoC to determine at least the first transform kernel set when a size of the current block is larger than a threshold size; using the HoC to determine at least the first transform kernel set when the current block is a luma block; and using the HoC to determine at least the first transform kernel set when the current block is in a specific type of slice.
(12). A method of video encoding, including: determining to code a current block in a current picture using an intra prediction that generates prediction samples of the current block based on reference samples in the current picture; determining at least a first transform kernel set based on a histogram of occurrence (HoC) of intra prediction modes in neighboring samples of the current block; calculating transform coefficients of a residual block for the intra prediction of the current block according to at least the first transform kernel set; and encoding the current block into coded information in a bitstream based on the transform coefficients.
(13). The method of feature (12), in which the determining at least the first transform kernel set includes: determining at least a first intra prediction mode based on the HoC of the intra prediction modes in the neighboring samples of the current block; and determining the first transform kernel set that maps to the first intra prediction mode according to a one-to-one mapping of the intra prediction modes to transform kernel sets.
(14). The method of any of features (12) to (13), in which the determining at least the first intra prediction mode includes: determining the first intra prediction mode that has a highest occurrence in the intra prediction modes of the HoC.
(15). The method of any of features (12) to (14), in which the determining at least the first intra prediction mode includes: determining the first intra prediction mode that has a second highest occurrence in the intra prediction modes of the HoC.
(16). The method of any of features (12) to (15), in which the determining at least the first intra prediction mode includes: determining the first intra prediction mode that has an occurrence value higher than a occurrence threshold according to the HoC.
(17). The method of any of features (12) to (16), in which the first intra prediction mode is a planar mode that is predefined.
(18). The method of any of features (12) to (17), in which the determining at least the first intra prediction mode includes: determining a highest occurrence mode that has a highest occurrence in the intra prediction modes of the HoC; and determining the first intra prediction mode by applying an offset to the highest occurrence mode.
(19). The method of any of features (12) to (18), in which the determining at least the first transform kernel set includes: determining at least a first intra prediction mode and a second intra prediction mode based on the HoC of the intra prediction modes in the neighboring samples of the current block; and determining the first transform kernel set and a second transform kernel that respectively map to the first intra prediction mode and the second intra prediction mode according to a one-to-one mapping of the intra prediction modes to transform kernel sets.
(20). The method of any of features (12) to (19), in which the determining at least the first transform kernel set includes: constructing a most probable transform kernel candidate list that includes a plurality of transform kernel sets based on the HoC of the intra prediction modes in the neighboring samples of the current block.
(21). The method of any of features (12) to (20), further including: encoding a syntax element into the coded information of the current block, the syntax element indicating a selected transform kernel set from at least the first kernel transform kernel set, the selected transform kernel set being used for the calculating of the residual block of the current block.
(22). The method of any of features (12) to (21), further including at least one of: using the HoC to determine at least the first transform kernel set when a size of the current block is larger than a threshold size; using the HoC to determine at least the first transform kernel set when the current block is a luma block; and using the HoC to determine at least the first transform kernel set when the current block is in a specific type of slice.
(23). A method of processing visual media data, the method including: processing a bitstream that includes the visual media data according to a format rule, in which: the bitstream carries a plurality of pictures; and the format rule specifies that: a current block in a current picture is coded using an intra prediction that generates prediction samples of the current block based on reference samples in the current picture; at least a first transform kernel set is determined based on a histogram of occurrence (HoC) of intra prediction modes in neighboring samples of the current block; a residual block of the current block is calculated according to at least the first transform kernel set; and the current block is reconstructed based on the residual block and the intra prediction of the current block.
(24). A method of video decoding, including: receiving a coded video bitstream including coded information of a plurality of pictures; determining, based on coded information of a current block in a current picture, that the current block is coded in an intra block copy (IBC) mode that generates a prediction block of the current block based on a block vector that points to a reference block in the current picture; determining a transform kernel set from a plurality of transform kernel sets based on a syntax element; calculating, based on the coded information of the current block, a residual block of the current block according to the transform kernel set; and reconstructing the current block based on the residual block and the prediction block of the current block.
(25). A method of video encoding, including: determining to code a current block in a current picture using an intra block copy (IBC) mode that generates a prediction block of the current block based on a block vector that points to a reference block in the current picture; determining a transform kernel set from a plurality of transform kernel sets; calculating transform coefficients of a residual block for the prediction block of the current block according to the transform kernel set; and encoding the current block into coded information in a bitstream based on the transform coefficients.
(26). A method of processing visual media data, the method including: processing a bitstream that includes the visual media data according to a format rule, in which: the bitstream carries a plurality of pictures; and the format rule specifies that: based on coded information of a current block in a current picture, the current block is determined in an intra block copy (IBC) mode that generates a prediction block of the current block based on a block vector that points to a reference block in the current picture; a transform kernel set is selected from a plurality of transform kernel sets based on a syntax element; based on the coded information of the current block, a residual block of the current block is calculated according to the transform kernel set; and the current block is reconstructed based on the residual block and the prediction block of the current block.
(27). A method of video decoding, including: receiving a coded video bitstream including coded information of a plurality of pictures; determining, based on coded information of a current block in a current picture, that the current block is coded in an intra block copy (IBC) mode that generates a prediction block of the current block based on a block vector that points to a reference block in the current picture; inheriting transform kernel selection information of the current block from the reference block; determining a transform kernel based on the transform kernel selection information; calculating, based on the coded information of the current block, a residual block of the current block according to the transform kernel; and reconstructing the current block based on the residual block and the prediction block of the current block.
(28). A method of video encoding, including: determining to code a current block in a current picture using an intra block copy (IBC) mode that generates a prediction block of the current block based on a block vector that points to a reference block in the current picture; inheriting transform kernel selection information of the current block from the reference block; determining a transform kernel based on the transform kernel selection information; calculating transform coefficients of a residual block for the prediction block of the current block according to the transform kernel; and encoding the current block into coded information in a bitstream based on the transform coefficients.
(29). A method of processing visual media data, the method including: processing a bitstream that includes the visual media data according to a format rule, in which: the bitstream carries a plurality of pictures; and the format rule specifies that: based on coded information of a current block in a current picture, the current block is determined in an intra block copy (IBC) mode that generates a prediction block of the current block based on a block vector that points to a reference block in the current picture; transform kernel selection information of the current block is inherited from the reference block; a transform kernel is determined based on the transform kernel selection information; based on the coded information of the current block, a residual block of the current block is calculated according to the transform kernel; and the current block is reconstructed based on the residual block and the prediction block of the current block.
(30). A method of video decoding, including: receiving a coded video bitstream including coded information of a plurality of pictures; determining, based on coded information of a current block in a current picture, that the current block is coded by a fusion based intra prediction that generates a fusion prediction signal of the current block based on one or more prediction signal components; determining one or more transform kernel candidates based on the one or more prediction signal components; selecting a transform kernel from the one or more transform kernel candidates; calculating, based on the coded information of the current block, a residual block of the current block according to the transform kernel; and reconstructing the current block based on the residual block.
(31). A method of video encoding, including: determining to code a current block in a current picture using a fusion based intra prediction that generates a fusion prediction signal of the current block based on one or more prediction signal components; determining one or more transform kernel candidates based on the one or more prediction signal components; determining a transform kernel from the one or more transform kernel candidates; calculating transform coefficients of a residual block of the current block according to the transform kernel; and encoding the current block into coded information in a bitstream based on the transform coefficients.
(32). A method of processing visual media data, the method including: processing a bitstream that includes the visual media data according to a format rule, in which: the bitstream carries a plurality of pictures; and the format rule specifies that: based on coded information of a current block in a current picture, the current block is coded by a fusion based intra prediction that generates a fusion prediction signal of the current block based on one or more prediction signal components; one or more transform kernel candidates are determined based on the one or more prediction signal components; a transform kernel is selected from the one or more transform kernel candidates; based on the coded information of the current block, a residual block of the current block is calculated according to the transform kernel; and the current block is reconstructed based on the residual block.
(33). A method of video decoding, including: receiving a coded video bitstream including coded information of a plurality of pictures; determining, based on coded information of a current block in a current picture, that the current block is coded using an intra prediction that generates prediction samples of the current block based on reference samples in the current picture; determining an offset value for a set index, the offset value being adaptively adjusted based on the coded information of the current block; determining a transform kernel set based on the set index and the offset value; calculating, based on the coded information of the current block, a residual block of the current block according to the transform kernel set; and reconstructing the current block based on the residual block and the intra prediction of the current block.
(34). A method of video encoding, including: determining to code a current block in a current picture using an intra prediction that generates prediction samples of the current block based on reference samples in the current picture; determining a transform kernel set from multiple transform kernel set candidates, the transform kernel set having a transform set index that is a combination of a set index and an offset value, the offset value being adaptively adjusted based on the current block; calculating transform coefficients of a residual block of the current block according to the transform kernel set; and encoding the current block into coded information in a bitstream based on the transform coefficients.
(35). A method of processing visual media data, the method including: processing a bitstream that includes the visual media data according to a format rule, in which: the bitstream carries a plurality of pictures; and the format rule specifies that: based on coded information of a current block in a current picture, the current block is determined to be coded using an intra prediction that generates prediction samples of the current block based on reference samples in the current picture; an offset value for a set index is determined, the offset value being adaptively adjusted based on the coded information of the current block; a transform kernel set is selected based on the set index and the offset value; based on the coded information of the current block, a residual block of the current block is calculated according to the transform kernel set; and the current block is reconstructed based on the residual block and the intra prediction of the current block.
(36). A method of video decoding, including: receiving a coded video bitstream including coded information of a plurality of pictures; determining, based on coded information of a current block in a current picture, that the current block is coded in an adaptive transform kernel derivation mode with intra and inter partitions, the current block being partitioned into at least a first partition and a second partition, the first partition being predicted based on a vector that points to a reference block and the second partition being predicted by an intra prediction; determining an intra prediction mode from a plurality of candidate intra prediction modes for the current block based on the coded information of the current block; determining a transform kernel set based on the intra prediction mode; calculating a residual block of the current block according to the transform kernel set and the coded information of the current block; and reconstructing the current block based on the residual block, the reference block of the first partition and the intra prediction of the second partition.
(37). The method of feature (36), in which the current block is partitioned with a non-rectangular boundary.
(38). The method of any of features (36) to (37), in which the current block is partitioned with a rectangular boundary.
(39). The method of any of features (36) to (38), in which the plurality of candidate intra prediction modes include a first candidate intra prediction mode associated with a partition direction of the current block.
(40). The method of any of features (36) to (39), further including: determining the first candidate intra prediction mode according to a predefined lookup table that maps partition directions to intra prediction modes.
(41). The method of any of features (36) to (40), in which the plurality of candidate intra prediction modes include a second candidate intra prediction mode that is derived based on a histogram of gradients associated with the current block.
(42). The method of any of features (36) to (41), further including: building the histogram of gradients according to predicted samples of the current block, the gradients being mapped to intra prediction modes; ranking the intra prediction modes based on the histogram of gradients; and determining the second candidate intra prediction mode according to the intra prediction modes that are ranked based on the histogram of gradients.
(43). The method of any of features (36) to (42), in which the second candidate intra prediction mode is a most frequent mode based on the histogram of gradients.
(44). The method of any of features (36) to (43), in which the second candidate intra prediction mode is a second most frequent mode.
(45). The method of any of features (36) to (44), in which the plurality of candidate intra prediction modes include a first candidate intra prediction mode associated with a partition direction of the current block and a second candidate intra prediction mode that is derived based on a histogram of gradients associated with the current block, and the method includes: selecting the intra prediction mode from the first candidate intra prediction mode and the second candidate intra prediction mode based on a similarity between the first candidate intra prediction mode and the second candidate intra prediction mode.
(46). The method of any of features (36) to (45), in which the selecting includes: selecting the first candidate intra prediction mode as the intra prediction mode when a difference between the first candidate intra prediction mode and the second candidate intra prediction mode is smaller than a threshold; and selecting the second candidate intra prediction mode as the intra prediction mode when the difference is equal to or larger than the threshold.
(47). The method of any of features (36) to (46), in which the first partition is predicted based on at least one of: a motion vector based inter prediction; and a block vector based intra block copy.
(48). The method of any of features (36) to (47), in which the first partition is predicted according to a block vector that is signaled in the coded video bitstream.
(49). The method of any of features (36) to (48), in which the first partition is predicted according to a block vector that is derived according to a template matching.
(50). The method of any of features (36) to (49), further including: decoding a syntax element that indicates an activation of the adaptive transform kernel derivation mode with intra and inter partitions.
(51). The method of any of features (36) to (50), further including: determining whether the adaptive transform kernel derivation mode with intra and inter partitions is activated based on coded information of the current block and coded information of blocks that are decoded before the current block.
(52). A method of video encoding, including: determining, to code a current block in a current picture in an adaptive transform kernel derivation mode with intra and inter partitions, the current block being partitioned into at least a first partition and a second partition, the first partition being predicted based on a vector that points to a reference block and the second partition being predicted by an intra prediction; determining an intra prediction mode from a plurality of candidate intra prediction modes for the current block; determining a transform kernel set based on the intra prediction mode; calculating transform coefficients for a residual block of the current block according to the transform kernel set; and encoding the current block into coded information in a bitstream based on the transform coefficients.
(53). The method of feature (52), in which the current block is partitioned with a non-rectangular boundary.
(54). The method of any of features (52) to (53), in which the current block is partitioned with a rectangular boundary.
(55). The method of any of features (52) to (54), in which the plurality of candidate intra prediction modes include a first candidate intra prediction mode associated with a partition direction of the current block.
(56). The method of any of features (52) to (55), further including: determining the first candidate intra prediction mode according to a predefined lookup table that maps partition directions to intra prediction modes.
(57). The method of any of features (52) to (56), in which the plurality of candidate intra prediction modes include a second candidate intra prediction mode that is derived based on a histogram of gradients associated with the current block.
(58). The method of any of features (52) to (57), further including: building the histogram of gradients according to predicted samples of the current block, the gradients being mapped to intra prediction modes; ranking the intra prediction modes based on the histogram of gradients; and determining the second candidate intra prediction mode according to the intra prediction modes that are ranked based on the histogram of gradients.
(59). The method of any of features (52) to (58), in which the second candidate intra prediction mode is a most frequent mode based on the histogram of gradients.
(60). The method of any of features (52) to (59), in which the second candidate intra prediction mode is a second most frequent mode.
(61). The method of any of features (52) to (60), in which the plurality of candidate intra prediction modes include a first candidate intra prediction mode associated with a partition direction of the current block and a second candidate intra prediction mode that is derived based on a histogram of gradients associated with the current block, and the method includes: selecting the intra prediction mode from the first candidate intra prediction mode and the second candidate intra prediction mode based on a similarity between the first candidate intra prediction mode and the second candidate intra prediction mode.
(62). The method of any of features (52) to (61), in which the selecting includes: selecting the first candidate intra prediction mode as the intra prediction mode when a difference between the first candidate intra prediction mode and the second candidate intra prediction mode is smaller than a threshold; and selecting the second candidate intra prediction mode as the intra prediction mode when the difference is equal to or larger than the threshold.
(63). The method of any of features (52) to (62), in which the first partition is predicted based on at least one of: a motion vector based inter prediction; and a block vector based intra block copy.
(64). The method of any of features (52) to (63), in which the first partition is predicted according to a block vector, and the method includes: encoding the block vector in the bitstream.
(65). The method of any of features (52) to (64), in which the first partition is predicted according to a block vector, and the method includes: deriving the block vector according to a template matching.
(66). The method of any of features (52) to (65), further including: encoding a syntax element into the bitstream, the syntax element indicating an activation of the adaptive transform kernel derivation mode with intra and inter partitions.
(67). A method of processing visual media data, the method including: processing a bitstream that includes the visual media data according to a format rule, in which: the bitstream carries a plurality of pictures; and the format rule specifies that: based on coded information of a current block in a current picture, the current block is determined in an adaptive transform kernel derivation mode with intra and inter partitions, the current block being partitioned into at least a first partition and a second partition, the first partition being predicted based on a vector that points to a reference block and the second partition being predicted by an intra prediction; an intra prediction mode is selected from a plurality of candidate intra prediction modes for the current block based on the coded information of the current block; a transform kernel set is determined based on the intra prediction mode; a residual block of the current block is calculated according to the transform kernel set and the coded information of the current block; and the current block is reconstructed based on the residual block, the reference block of the first partition and the intra prediction of the second partition.
(68). A method of video decoding, including: receiving a coded video bitstream including coded information of a plurality of pictures; determining that a chroma block is predicted by a cross-component prediction according to a corresponding luma block; determining a transform kernel set from transform kernel set information of the corresponding luma block, the transform kernel set information indicating a plurality of transform kernel sets; calculating a residual block of the chroma block according to the transform kernel set; and reconstructing the chroma block based on the residual block.
(69). A method of video encoding, including: determining to code a chroma block by a cross-component prediction according to a corresponding luma block; determining a transform kernel set from transform kernel set information of the corresponding luma block, the transform kernel set information indicating a plurality of transform kernel sets; calculating transform coefficients for a residual block of the chroma block according to the transform kernel set; and encoding the chroma block into coded information in a bitstream based on the transform coefficients.
(70). A method of processing visual media data, the method including: processing a bitstream that includes the visual media data according to a format rule, in which: the bitstream carries a plurality of pictures; and the format rule specifies that: a chroma block is determined to be predicted by a cross-component prediction according to a corresponding luma block; a transform kernel set is determined from transform kernel set information of the corresponding luma block, the transform kernel set information indicating a plurality of transform kernel sets; a residual block of the chroma block is calculated according to the transform kernel set; and the chroma block is reconstructed based on the residual block.
(71). A method of video decoding, including: receiving a coded video bitstream including coded information of a plurality of pictures; determining, based on coded information of a current block, one or more variances to a decoder-side intra mode derivation for the current block; deriving a transform kernel set based on the decoder-side intra mode derivation with the one or more variances; calculating a residual block of the current block according to the transform kernel set; and reconstructing the current block based on the residual block.
(72). A method of video encoding, including: determining to code a current block with one or more variances to a decoder-side intra mode derivation for the current block; deriving a transform kernel set based on the decoder-side intra mode derivation with the one or more variances; calculating transform coefficients for a residual block of the current block according to the transform kernel set; and encoding the current block into coded information in a bitstream based on the transform coefficients.
(73). A method of processing visual media data, the method including: processing a bitstream that includes the visual media data according to a format rule, in which: the bitstream carries a plurality of pictures; and the format rule specifies that: based on coded information of a current block, one or more variances to a decoder-side intra mode derivation for the current block are determined; a transform kernel set is derived based on the decoder-side intra mode derivation with the one or more variances; a residual block of the current block is calculated according to the transform kernel set; and the current block is reconstructed based on the residual block.
(74). An apparatus for video decoding, including processing circuitry that is configured to perform the method of any of features (1) to (11).
(75). An apparatus for video encoding, including processing circuitry that is configured to perform the method of any of features (12) to (22).
(76). An apparatus for video decoding, including processing circuitry that is configured to perform the method of feature (24).
(77). An apparatus for video encoding, including processing circuitry that is configured to perform the method of features (25).
(78). An apparatus for video decoding, including processing circuitry that is configured to perform the method of feature (27).
(79). An apparatus for video encoding, including processing circuitry that is configured to perform the method of features (28).
(80). An apparatus for video decoding, including processing circuitry that is configured to perform the method of feature (30).
(81). An apparatus for video encoding, including processing circuitry that is configured to perform the method of features (31).
(82). An apparatus for video decoding, including processing circuitry that is configured to perform the method of feature (33).
(83). An apparatus for video encoding, including processing circuitry that is configured to perform the method of features (34).
(84). An apparatus for video decoding, including processing circuitry that is configured to perform the method of any of features (36) to (51).
(85). An apparatus for video encoding, including processing circuitry that is configured to perform the method of any of features (52) to (66).
(86). An apparatus for video decoding, including processing circuitry that is configured to perform the method of feature (68).
(87). An apparatus for video encoding, including processing circuitry that is configured to perform the method of features (69).
(88). An apparatus for video decoding, including processing circuitry that is configured to perform the method of feature (71).
(89). An apparatus for video encoding, including processing circuitry that is configured to perform the method of features (72).
(90). A non-transitory computer-readable storage medium storing instructions which when executed by at least one processor cause the at least one processor to perform the method of any of features (1) to (73).

What is claimed is:

1. A method of video decoding, comprising:
receiving a coded video bitstream comprising coded information of a plurality of pictures;
determining, based on coded information of a current block in a current picture, that the current block is coded using an intra prediction that generates prediction samples of the current block based on reference samples in the current picture;
determining at least a first transform kernel set based on a histogram of occurrence (HoC) of intra prediction modes in neighboring samples of the current block;
calculating, based on the coded information of the current block, a residual block of the current block according to at least the first transform kernel set; and
reconstructing the current block based on the residual block and the intra prediction of the current block.

2. The method of claim 1, wherein the determining at least the first transform kernel set comprises:
determining at least a first intra prediction mode based on the HoC of the intra prediction modes in the neighboring samples of the current block; and
determining the first transform kernel set that maps to the first intra prediction mode according to a one-to-one mapping of the intra prediction modes to transform kernel sets.

3. The method of claim 2, wherein the determining at least the first intra prediction mode comprises:
determining the first intra prediction mode that has a highest occurrence in the intra prediction modes of the HoC.

4. The method of claim 2, wherein the determining at least the first intra prediction mode comprises:
determining the first intra prediction mode that has a second highest occurrence in the intra prediction modes of the HoC.

5. The method of claim 2, wherein the determining at least the first intra prediction mode comprises:
determining the first intra prediction mode that has an occurrence value higher than an occurrence threshold according to the HoC.

6. The method of claim 2, wherein the first intra prediction mode is a planar mode that is predefined.

7. The method of claim 2, wherein the determining at least the first intra prediction mode comprises:
determining a highest occurrence mode that has a highest occurrence in the intra prediction modes of the HoC; and
determining the first intra prediction mode by applying an offset to the highest occurrence mode.

8. The method of claim 1, wherein the determining at least the first transform kernel set comprises:
determining at least a first intra prediction mode and a second intra prediction mode based on the HoC of the intra prediction modes in the neighboring samples of the current block; and
determining the first transform kernel set and a second transform kernel that respectively map to the first intra prediction mode and the second intra prediction mode according to a one-to-one mapping of the intra prediction modes to transform kernel sets.

9. The method of claim 1, wherein the determining at least the first transform kernel set comprises:
constructing a most probable transform kernel candidate list that includes a plurality of transform kernel sets based on the HoC of the intra prediction modes in the neighboring samples of the current block.

10. The method of claim 1, further comprising:
decoding a syntax element from the coded information of the current block, the syntax element indicating a selected transform kernel set from at least the first transform kernel set, the selected transform kernel set being used for the calculating of the residual block of the current block.

11. A method of video decoding, comprising:
receiving a coded video bitstream comprising coded information of a plurality of pictures;
determining, based on coded information of a current block in a current picture, that the current block is coded in an adaptive transform kernel derivation mode with intra and inter partitions, the current block being partitioned into at least a first partition and a second partition, the first partition being predicted based on a vector that points to a reference block and the second partition being predicted by an intra prediction;
determining an intra prediction mode from a plurality of candidate intra prediction modes for the current block based on the coded information of the current block;
determining a transform kernel set based on the intra prediction mode;
calculating a residual block of the current block according to the transform kernel set and the coded information of the current block; and
reconstructing the current block based on the residual block, the reference block of the first partition and the intra prediction of the second partition.

12. The method of claim 11, wherein the current block is partitioned with a non-rectangular boundary.

13. The method of claim 11, wherein the current block is partitioned with a rectangular boundary.

14. The method of claim 11, wherein the plurality of candidate intra prediction modes include a first candidate intra prediction mode associated with a partition direction of the current block.

15. The method of claim 14, further comprising:
determining the first candidate intra prediction mode according to a predefined lookup table that maps partition directions to intra prediction modes.

16. The method of claim 11, wherein the plurality of candidate intra prediction modes include a second candidate intra prediction mode that is derived based on a histogram of gradients associated with the current block.

17. The method of claim 16, further comprising:
building the histogram of gradients according to predicted samples of the current block, the gradients being mapped to intra prediction modes;
ranking the intra prediction modes based on the histogram of gradients; and
determining the second candidate intra prediction mode according to the intra prediction modes that are ranked based on the histogram of gradients.

18. The method of claim 17, wherein the second candidate intra prediction mode is a most frequent mode based on the histogram of gradients.

19. The method of claim 17, wherein the second candidate intra prediction mode is a second most frequent mode based on the histogram of gradients.

20. The method of claim 11, wherein the plurality of candidate intra prediction modes include a first candidate intra prediction mode associated with a partition direction of the current block and a second candidate intra prediction mode that is derived based on a histogram of gradients associated with the current block, and the method comprises:
selecting the intra prediction mode from the first candidate intra prediction mode and the second candidate intra prediction mode based on a similarity between the first candidate intra prediction mode and the second candidate intra prediction mode.
